(19) United States
(12) Patent Application Publication
(10) Pub. No.: US 2026/0128508 A1
(43) Pub. Date: May 7, 2026

(54) ELECTRONIC DEVICE COMPRISING ANTENNA

(71) Applicant: Samsung Electronics Co., Ltd., Suwon-si (KR)

(72) Inventors: Juneseok LEE, Suwon-si (KR); Sanghoon PARK, Suwon-si (KR); Sohyeon JUNG, Suwon-si (KR); Jungyub LEE, Suwon-si (KR)

(21) Appl. No.: 19/434,895

(22) Filed: Dec. 29, 2025

Related U.S. Application Data
(63) Continuation of application No. PCT/KR2024/006044, filed on May 3, 2024.

(30) Foreign Application Priority Data
Jun. 29, 2023 (KR) 10-2023-0084427
Aug. 24, 2023 (KR) 10-2023-0111606

(51) Int. Cl. H01Q 1/52; H01Q 1/24; H01Q 9/26; H01Q 15/24

(52) U.S. Cl. CPC H01Q 1/523; H01Q 1/246; H01Q 9/26; H01Q 15/24

(57) ABSTRACT

An antenna module is provided. The antenna module includes an insulating plate including at least one conductive pattern, and a plurality of radiation structures disposed on a surface of the insulating plate, wherein each radiation structure of the plurality of radiation structures includes a substrate portion and a support portion disposed between the substrate portion and the insulating plate, wherein the substrate portion includes a non-conductive substrate and a metal pattern formed on the non-conductive substrate and configured to radiate signals, wherein the support portion includes a plurality of side areas and a feeding area, wherein the at least one conductive pattern is electrically connected to a first feeding portion for a first polarization and a second feeding portion for a second polarization, wherein the first feeding portion is disposed along at least one first side area among the plurality of side areas of the support portion and the feeding area, and wherein the second feeding portion is disposed along at least one second side area among the plurality of side areas of the support portion and the feeding area.

### CROSS-REFERENCE TO RELATED APPLICATION(S)

This application is a continuation application, claiming priority under 35 U.S.C. § 365(c), of an International application No. PCT/KR2024/006044, filed on May 3, 2024, which is based on and claims the benefit of a Korean patent application number 10-2023-0084427, filed on Jun. 29, 2023, in the Korean Intellectual Property Office, and of a Korean patent application number 10-2023-0111606, filed on Aug. 24, 2023, in the Korean Intellectual Property Office, the disclosure of each of which is incorporated by reference herein in its entirety.

### BACKGROUND

### 1. Field

The disclosure relates to an electronic device including an antenna.

### 2. Description of Related Art

As one of technologies for mitigating a propagation path loss and increasing a transmission distance of radio waves, a beamforming technology is used. Beamforming, in general, concentrates a coverage of the radio waves by using a plurality of antennas or increases a directivity of reception sensitivity with respect to a specific direction. To operate the beamforming technology, a communication node may be provided with the plurality of antennas.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device including an antenna.

Additional aspects will be set forth in part in the description which follows and, in part, will be apparent from the description, or may be learned by practice of the presented embodiments.

In accordance with an aspect of the disclosure, an antenna module is provided. The antenna module includes an insulating plate including at least one conductive pattern, and a plurality of radiation structures disposed on a surface of the insulating plate, wherein each radiation structure of the plurality of radiation structures includes a substrate portion and a support portion disposed between the substrate portion and the insulating plate, wherein the substrate portion includes a non-conductive substrate and a metal pattern formed on the non-conductive substrate and configured to radiate signals, wherein the support portion includes a plurality of side areas and a feeding area, wherein the at least one conductive pattern is electrically connected to a first feeding portion for a first polarization and a second feeding portion for a second polarization, wherein the first feeding portion is disposed along at least one first side area among the plurality of side areas of the support portion and the feeding area, and wherein the second feeding portion is disposed along at least one second side area among the plurality of side areas of the support portion and the feeding area.

In accordance with an aspect of the disclosure, a communication apparatus is provided. The communication apparatus includes a processor, at least one wireless communication circuitry, and an antenna module comprising a plurality of sub-arrays, wherein, for each sub-array, the antenna module includes an insulating plate including at least one conductive pattern, and a plurality of radiation structures disposed on a surface of the insulating plate, wherein each radiation structure of the plurality of radiation structures includes a substrate portion and a support portion disposed between the substrate portion and the insulating plate, wherein the substrate portion includes a non-conductive substrate and a metal pattern formed on the non-conductive substrate and configured to radiate signals, wherein the support portion includes a plurality of side areas and a feeding area, wherein the at least one conductive pattern is electrically connected to a first feeding portion for a first polarization and a second feeding portion for a second polarization, wherein the first feeding portion is disposed along at least one first side area among the plurality of side areas of the support portion and the feeding area, and wherein the second feeding portion is disposed along at least one second side area among the plurality of side areas of the support portion and the feeding area.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 indicates a wireless communication system according to an embodiment of the disclosure;

FIGS. 2A, 2B, and 2C indicate an example of a radiation structure for a dipole antenna according to various embodiments of the disclosure;

FIGS. 3A, 3B, and 3C indicate another example of a radiation structure for a dipole antenna according to various embodiments of the disclosure;

FIG. 4 indicates an example of a radiation pattern of an antenna module using a dipole antenna according to an embodiment of the disclosure;

FIG. 5A indicates a cross-section of a radiation structure for a dipole antenna according to an embodiment of the disclosure;

FIG. 5B indicates an example of feeding lines of a radiation structure for a dipole antenna according to an embodiment of the disclosure;

FIG. 6A indicates examples of a via for a radiation structure for a dipole antenna according to an embodiment of the disclosure;

FIG. 6B indicates an example of a method for generating a radiation structure for a dipole antenna according to an embodiment of the disclosure;

FIG. 7 indicates an example of a metal pattern for a dipole antenna according to an embodiment of the disclosure;

FIGS. 8A, 8B, and 8C indicate an example of an antenna element including a pillar structure for beamforming control according to various embodiments of the disclosure;

FIG. 9 indicates an example of performance of an antenna element including a pillar structure for beamforming control according to an embodiment of the disclosure;

FIG. 10 indicates an example of a conductive portion of a pillar structure for beamforming control according to an embodiment of the disclosure;

FIG. 11 is a diagram for describing a principle of beamforming control using a pillar structure according to an embodiment of the disclosure;

FIGS. 12A, 12B, and 12C indicates examples of performance of a sub-array for a dipole antenna according to various embodiments of the disclosure;

FIGS. 13A, 13B, 13C, and 13D indicates examples of an antenna module including a radiation structure for a dipole antenna according to various embodiments of the disclosure; and

FIG. 14 illustrates an example of a functional component of an electronic device including a radiation structure for a dipole antenna according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In various embodiments of the disclosure described below, a hardware approach will be described as an example. However, since the various embodiments of the disclosure include technology that uses both hardware and software, the various embodiments of the disclosure do not exclude a software-based approach.

A term referring to a component of an electronic device (e.g., insulating plate, substrate, printed circuit board (PCB), flexible PCB (FPCB), module, antenna, antenna component, antenna element, circuitry, amplifier circuitry, processor, chip, components, or device), a term referring to a shape of a component (e.g., opening, structure, structure body, support portion, contact portion, or protrusion), a term referring to a connection portion between structures (e.g., connection portion, contact portion, support portion, contact structure, conductive member, or assembly), a term referring to circuitry (e.g., PCB, FPCB, signal line, feeding line, data line, RF signal line, antenna line, amplifier circuitry, RF path, RF module, RF circuitry, splitter, divider, coupler, or combiner), and the like, that are used in the following description, are exemplified for convenience of description. Therefore, the disclosure is not limited to terms to be described below, and another term having an equivalent technical meaning may be used. In addition, a term such as ‘. . . unit’, ‘. . . device’, ‘. . . object’, and ‘. . . structure’, and the like used below may mean at least one shape structure or may mean a unit processing a function.

In addition, in the disclosure, the term ‘greater than’ or ‘less than’ may be used to determine whether a particular condition is satisfied or fulfilled, but this is only a description to express an example and does not exclude description of ‘greater than or equal to’ or ‘less than or equal to’. A condition described as ‘greater than or equal to ’ may be replaced with ‘greater than’, a condition described as ‘less than or equal to’ may be replaced with ‘less than’, and a condition described as ‘greater than or equal to and less than’ may be replaced with ‘greater than and less than or equal to’. In addition, hereinafter, ‘A’ to ‘B’ refers to at least one of elements from A (including A) to B (including B). Hereinafter, ‘C’ and/or ‘D’ means including at least one of ‘C’ or ‘D’, that is, {‘C’, ‘D’, and ‘C’ and ‘D’}.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

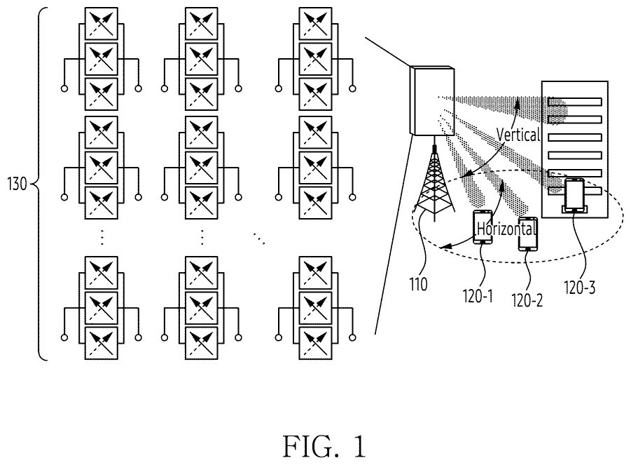

FIG. 1 indicates a wireless communication system according to an embodiment of the disclosure. A wireless communication environment of FIG. 1, which is a portion of nodes using a wireless channel, may illustrate a base station 110 and a terminal 120 (e.g., a first terminal 120-1, a second terminal 120-2, and a third terminal 120-3).

Referring to FIG. 1, the base station 110 is a network infrastructure for providing wireless access to the terminal 120. The base station 110 has a coverage based on a distance capable of transmitting a signal. In addition to the base station, the base station 110 may be referred to as an ‘access point (AP)’, an ‘eNodeB (eNB)’, a ‘5th generation node (5G node)’, a ‘5G NodeB (NB)’, a ‘wireless point’, a ‘transmission/reception point (TRP)’, an ‘access unit’, a ‘distributed unit (DU)’, a ‘transmission/reception point (TRP)’, a ‘radio unit (RU)’, a ‘remote radio head (RRH)’, or another term having an equivalent technical meaning. The base station 110 may transmit a downlink signal or receive an uplink signal.

The terminal 120, which is a device used by a user, may communicate with the base station 110 through a wireless channel. In some cases, the terminal 120 may be operated without user involvement. That is, the terminal 120, which is a device that performs machine type communication (MTC), may not be carried by the user. In addition to the terminal, the terminal 120 may be referred to as ‘user equipment (UE), a ‘mobile station’, a ‘subscriber station’, ‘customer premises equipment (CPE),’ a ‘remote terminal’, a ‘wireless terminal’, an ‘electronic device’, a ‘terminal for a vehicle’, a ‘user device’, or another term having the same technical meaning.

As one of technologies for mitigating a propagation path loss and increasing a transmission distance of radio waves, a beamforming technology is used. Beamforming, in general, concentrates a reach area of the radio waves by using a plurality of antennas or increases a directivity of reception sensitivity with respect to a specific direction. Therefore, in order to form a beamforming coverage instead of forming a signal in an isotropic pattern using a single antenna, the base station 110 may be provided with the plurality of antennas. According to an embodiment, the base station 110 may include a Massive Multiple Input Multiple Output (MIMO) Unit (MMU). A form in which the plurality of antennas are aggregated may be referred to as an antenna array 130, and each antenna included in the array may be referred to as an array element or an antenna element. The antenna array 130 may be configured in various forms such as a linear array and a planar array. The antenna array 130 may be referred to as a massive antenna array.

A key technology for enhancing a data capacity of 5G communication is a beamforming technology using an antenna array connected to a plurality of RF paths. For higher data capacity, the number of RF paths should be increased or power per RF path should be increased. Increasing the number of RF paths makes a product size larger, and due to spatial constraints in installing actual base station equipment, the number of RF paths cannot be further increased at present. Without increasing the number of RF paths, in order to increase antenna gain through higher output, the antenna gain may be increased by connecting a plurality of antenna elements using a divider (or a splitter) in the RF path. Herein, the antenna elements corresponding to the RF path may be referred to as a sub-array.

In order to enhance communication performance, the number of antennas (or antenna elements) of equipment (e.g., the base station 110) performing wireless communication is increasing. In addition, as the number of RF parts (e.g., amplifier, or filter) and components for processing RF signals received or transmitted through the antenna elements are also increased, in configuring communication equipment, spatial gain and cost efficiency are necessarily required while satisfying communication performance.

In FIG. 1, the base station 110 of FIG. 1 is described as an example to describe an electronic device including an antenna, however, embodiments of the disclosure are not limited thereto. As the electronic device according to the embodiments of the disclosure, in addition to the base station 110, it is also possible to use wireless equipment performing functions equivalent to those of the base station, wireless equipment (e.g., a TRP) connected to the base station, the terminal 120 of FIG. 1, or any other communication equipment used for 5G communication. Hereinafter, in the disclosure, an antenna array composed of sub-arrays is described as an example as a structure of the plurality of antennas for communication in the Multiple Input Multiple Output (MIMO) environment, but it goes without saying that easy changes for beamforming are possible in some embodiments.

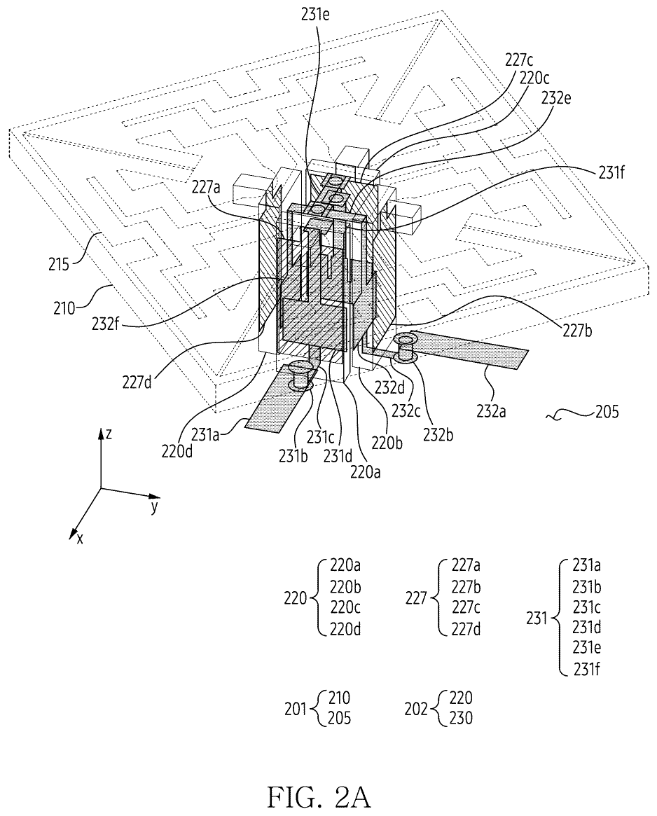

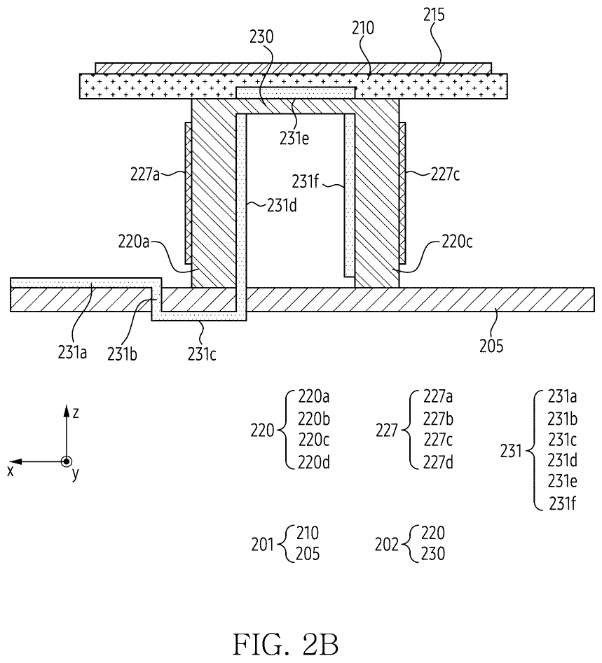

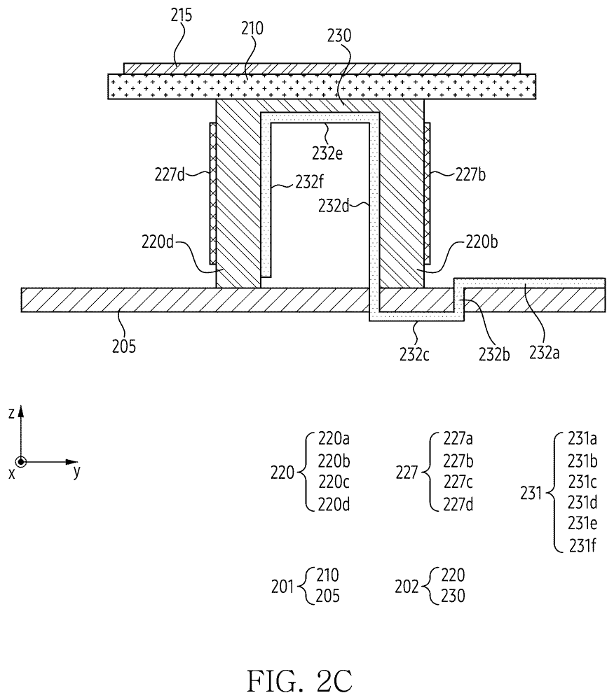

FIGS. 2A to 2C indicate an example of a radiation structure for a dipole antenna according to various embodiments of the disclosure. An electronic device according to embodiments may include an antenna array. The antenna array may include a plurality of antenna elements. The radiation structure described in FIGS. 2A to 2C may correspond to an antenna element 200 among the plurality of antenna elements. The antenna element 200 may be used as the dipole antenna.

Referring to FIG. 2A, a perspective view of the antenna element 200 is illustrated. The antenna element 200 may include a radiation structure. The radiation structure may be disposed over a surface of an insulating plate 205. The radiation structure may include a structure used as a radiator. The radiation structure may include a dielectric and a conductive portion added to the dielectric. The radiation structure may include a substrate portion 201. The substrate portion may include a non-conductive substrate 210 and a metal pattern 215 formed on the non-conductive substrate 210. The non-conductive substrate 210 and the metal pattern 215 may be configured with different materials. For example, the non-conductive substrate 210 may be a dielectric. The metal pattern 215 may be a metal. The metal pattern 215 may be configured to radiate fed signals. In other words, the metal pattern 215 may be used as a radiator.

The radiation structure may include a support portion 202. The support portion 202 may be used to support the substrate portion 201 of the radiation structure. The support portion 202 may be disposed to maintain a constant distance such that the insulating plate 205 is spaced apart from the non-conductive substrate 210 of the substrate portion 201. The support portion 202 may be used to feed signals to the metal pattern 215 of the radiation structure. For example, the support portion 202 may feed signals through feeding portions formed on the support portion 202. The signals may be coupled and excited in the metal pattern 215. The excited signals may be radiated through the metal pattern 215. A detailed description regarding feeding of the signals will be described with reference to FIGS. 2B and 2C.

The support portion 202 may include a plurality of side areas 220 and a feeding area 230. A plurality of side areas 220 may include a first side area 220a, a second side area 220b, a third side area 220c, and a fourth side area 220d. The feeding area 230 may be coupled to the plurality of side areas 220, and may correspond to the uppermost surface in a shape of the support portion 202. For example, the shape of the support portion 202 may be a quadrangular pillar or a frustum of quadrangular pyramid. Hereinafter, the support portion 202 includes four side areas (e.g., the first side area 220a, the second side area 220b, the third side area 220c, and the fourth side area 220d), and the shape of the quadrangular pillar or the frustum of quadrangular pyramid is described as an example, but embodiments of the disclosure are not limited thereto. Any structure including a feed structure and a radiation structure described through embodiments may be understood as embodiments of the disclosure. The plurality of side areas 220 may include inner surfaces facing the inside of the support portion 202 and outer surfaces facing the outside of the support portion 202. The inner surfaces indicate side surfaces facing the center of the support portion 202, and the outer surfaces indicate side surfaces facing outward from the center of the support portion 202. According to an embodiment, a signal line (e.g., a first feeding portion 231 and a second feeding portion 232) may be formed on at least a portion of the inner surfaces. The signal line indicates a path through which a signal is fed. According to an embodiment, a ground area may be disposed on at least a portion of the outer surfaces. For example, the ground area may include a plating pattern formed on an outer surface of the dielectric. Through the ground area, noise components of RF signals that are fed through the signal line may be reduced, and stable transmission of the RF signals may be provided.

A conductive pattern may be formed on the insulating plate 205. The conductive pattern may be configured to transmit electrical signals provided from wireless communication circuitry (e.g., RFIC, wireless communication chip, or communication chip) to a radiator (e.g., the metal pattern 215). The conductive pattern may include a first conductive pattern for a first polarization. It may include a second conductive pattern for a second polarization. The first polarization and the second polarization may be substantially perpendicular. For example, the first polarization may be a vertical (V)-polarization, and the second polarization may be a horizontal (H)-polarization. For example, the first polarization may be (+) about 45 degrees polarization, and the second polarization may be (−) about 45 degrees polarization. The first conductive pattern may include the first feeding portion 231. The first feeding portion 231 may be a signal path for providing signals (e.g., signals of the first polarization) of the first conductive pattern to the metal pattern 215. The second feeding portion 232 may be a signal path for providing signals (e.g., signals of the second polarization) of the second conductive pattern to the metal pattern 215.

The first feeding portion 231 may be formed along at least one surface of the support portion 202. In order to be disposed along the at least one surface of the support portion 202 starting from the first conductive pattern over a surface of the insulating plate 205, the first feeding portion 231 may be divided into a plurality of segments. For example, the first feeding portion 231 may include a first feeding segment 231a and a second feeding segment 231b. The first feeding segment 231a may be a portion of the first feeding portion 231 formed on a surface of the insulating plate 205. The second feeding segment 231b may be a portion of the first feeding portion 231 formed on the surface of the insulating plate 205 and a surface opposite to the surface. As an example, the second feeding segment 231b may be a conductive via. A detailed structure regarding the first feeding portion 231 will be described with reference to FIGS. 2B and 2C.

The second feeding portion 232 may be formed along at least one surface of the support portion 202. In order to be disposed along the at least one surface of the support portion 202 starting from the second conductive pattern over a surface of the insulating plate 205, the second feeding portion 232 may be divided into a plurality of segments. For example, the second feeding portion 232 may include a first feeding segment 232a and a second feeding segment 232b. The first feeding segment 232a may be a portion of the second feeding portion 232 formed on a surface of the insulating plate 205. The second feeding segment 232b may be a portion of the second feeding portion 232 formed on the surface of the insulating plate 205 and a surface opposite to the surface. As an example, the second feeding segment 232b may be a conductive via. A detailed structure regarding the second feeding portion 232 will be described with reference to FIGS. 2B and 2C.

Referring to FIG. 2B, a cross-section of the antenna element 200 of FIG. 2A in a direction (e.g., in a −y axis direction) is illustrated. In FIG. 2B, an example of a feed structure of the first feeding portion 231 is described. The support portion 202 may be disposed over a surface of the insulating plate 205. The substrate portion 201 may be disposed over the support portion 202. The non-conductive substrate 210 of the substrate portion 201 may be disposed over the support portion 202. The metal pattern 215 may be formed on a surface of the non-conductive substrate 210. According to an embodiment, the non-conductive substrate 210 and the support portion 202 may be integrally formed.

The first feeding portion 231 may be formed along at least one side area (e.g., the first side area 220a, or the third side area 220c) among the plurality of side areas 220 of the support portion 202 and the feeding area 230. For example, the first feeding portion 231 may include the first feeding segment 231a, the second feeding segment 231b, a third feeding segment 231c, a fourth feeding segment 231d, a fifth feeding segment 231e, and a sixth feeding segment 231f. The first feeding segment 231a may be disposed over a surface (e.g., a surface facing a +z axis) of the insulating plate 205. The second feeding segment 231b may include vias formed on the surface (e.g., the surface facing the +z axis) of the insulating plate 205 and an opposite surface (e.g., a surface facing a −z axis). The third feeding segment 231c may be disposed over a surface (e.g., a surface facing the −z axis) of the insulating plate 205. The fourth feeding segment 231d may be disposed over a surface of the first side area 220a among the plurality of side areas 220. For example, the surface may be an inner surface of the first side area 220a. The fifth feeding segment 231e may be disposed over a surface of the feeding area 230. For example, the surface may be a surface facing a +z-axis direction (hereinafter, referred to as an outer surface). The first feeding portion 231 may further include connection structures (e.g., conductive vias) in order for a feeding line extending from an inner surface of the support portion 202 to be disposed over the surface of the feeding area 230. For example, the first feeding portion 231 may further include a first connection structure (e.g., conductive via) for connecting the fourth feeding segment 231d and the fifth feeding segment 231e and/or a second connection structure (e.g., conductive via) for connecting the fifth feeding segment 231e and the sixth feeding segment 231f. The sixth feeding segment 231f may be disposed over a surface of the third side area 220c among the plurality of side areas 220. For example, the surface may be an inner surface of the third side area 220c.

A first ground area 227a may be disposed over a surface of the first side area 220a of the support portion 202. For example, the surface may be an outer surface of the first side area 220a. A third ground area 227c may be disposed on a surface of the third side area 220c of the support portion 202. For example, the surface may be an outer surface of the third side area 220c. Through the first ground area 227a and the third ground area 227c, noise components of first signals of the first polarization of the first feeding portion 231 may be reduced, and the first signals may be stably fed. In FIG. 2B, an example in which a ground area is formed on an outer surface of a side area (e.g., the first side area 220a, or the third side area 220c), and a feeding portion for transmitting a signal is disposed on an inner surface of the side area (e.g., the first side area 220a, or the third side area 220c), has been described, but embodiments of the disclosure are not limited thereto. According to an embodiment, the ground area may be formed on the inner surface of the side area of the support portion 202, and the feeding portion for transmitting the signal may be disposed on the outer surface of the side area.

In FIG. 2B, an example in which the first feeding portion 231 is divided into six segments has been described, but embodiments of the disclosure are not limited thereto. The example divided in FIG. 2B is merely an example of portions of the feeding line divided along the support portion 202, and is not interpreted as limiting another embodiment. According to another embodiment, the first feeding portion 231 may include the first feeding segment 231a, the second feeding segment 231b, the third feeding segment 231c, the fourth feeding segment 231d, and the fifth feeding segment 231e, and may not include the sixth feeding segment 231f. According to another embodiment, the first feeding segment 231a of the first feeding portion 231 may be disposed on a surface (hereinafter, referred to as a second surface) opposite to a surface (hereinafter, referred to as a first surface) of the insulating plate 205 on which the antenna element 200 is disposed. For example, a conductive pattern may be formed on the second surface of the insulating plate 205. As the conductive pattern is disposed on the second surface, the first feeding segment 231a of the first feeding portion 231 may also be formed on the second surface. Accordingly, a conductive via connected over the first surface and the second surface of the insulating plate 205 may be omitted. The first feeding portion 231 includes the first feeding segment 231a, the third feeding segment 231c, the fourth feeding segment 231d, the fifth feeding segment 231e, and the sixth feeding segment 231f, and may not include the second feeding segment 231b.

Referring to FIG. 2C, a cross-section of the antenna element 200 of FIG. 2A in a direction (e.g., in a −x-axis direction) is illustrated. In FIG. 2C, an example of a feed structure of the second feeding portion 232 is described. The support portion 202 may be disposed over a surface of the insulating plate 205. The substrate portion 201 may be disposed over the support portion 202. The non-conductive substrate 210 of the substrate portion 201 may be disposed over the support portion 202. The metal pattern 215 may be formed on a surface of the non-conductive substrate 210. According to an embodiment, the non-conductive substrate 210 and the support portion 202 may be integrally formed.

The second feeding portion 232 may be formed along at least one side area (e.g., the second side area 220b, or the fourth side area 220d) among the plurality of side areas 220 of the support portion 202, and the feeding area 230. For example, the second feeding portion 232 may include the first feeding segment 232a, the second feeding segment 232b, a third feeding segment 232c, a fourth feeding segment 232d, a fifth feeding segment 232e, and a sixth feeding segment 232f. The first feeding segment 232a may be disposed over a surface (e.g., a surface facing the +z axis) of the insulating plate 205. The second feeding segment 231b may include vias formed on the surface (e.g., the surface facing the +z axis) of the insulating plate 205 and an opposite surface (e.g., a surface facing the −z axis). The third feeding segment 232c may be disposed over a surface (e.g., a surface facing the −z axis) of the insulating plate 205. The fourth feeding segment 232d may be disposed over a surface of the first side area 220a among the plurality of side areas 220. For example, the surface may be an inner surface of the first side area 220a. The fifth feeding segment 232e may be disposed over a surface of the feeding area 230. For example, the surface may be a surface (hereinafter, referred to as an inner surface) facing a −z axis direction. The fifth feeding segment 232e disposed over the inner surface of the feeding area 230 may be distinguished from the fifth feeding segment 231e disposed over the outer surface of the feeding area 230. The sixth feeding segment 232f may be disposed over a surface of the third side area 220c among the plurality of side areas 220. For example, the surface may be an inner surface of the third side area 220c.

A second ground area 227b may be disposed over a surface of the second side area 220b of the support portion 202. For example, the surface may be an outer surface of the second side area 220b. A fourth ground area 227d may be disposed over a surface of the fourth side area 220d of the support portion 202. For example, the surface may be an outer surface of the fourth side area 220d. Through the second ground area 227b and the fourth ground area 227d, noise components of second signals of the second polarization of the second feeding portion 232 may be reduced, and the second signals may be stably fed. In FIG. 2C, an example in which a ground area is formed on an outer surface of a side area (e.g., the second side area 220b, or the fourth side area 220d) and a feeding portion for transmitting a signal is disposed on an inner surface of a side area (e.g., the second side area 220b, or the fourth side area 220d), has been described, but embodiments of the disclosure are not limited thereto. According to an embodiment, the ground area is formed on the inner surface of the side area of the support portion 202 and the feeding portion for transmitting the signal may be disposed on the outer surface of the side area.

In FIG. 2C, an example in which the second feeding portion 232 is divided into six segments has been described, but embodiments of the disclosure are not limited thereto. The example divided in FIG. 2C is merely an example of portions of the feeding line divided along the support portion 202, and is not interpreted as limiting another embodiment. According to another embodiment, the second feeding portion 232 may include the first feeding segment 232a, the second feeding segment 232b, the third feeding segment 232c, the fourth feeding segment 232d, and the fifth feeding segment 232e, and may not include the sixth feeding segment 232f. According to another embodiment, the first feeding segment 232a of the second feeding portion 232 may be disposed on a surface (hereinafter, referred to as a second surface) opposite to a surface (hereinafter, referred to as a first surface) of the insulating plate 205 on which the antenna element 200 is disposed. For example, a conductive pattern may be formed on the second surface of the insulating plate 205. As the conductive pattern is disposed on the second surface, the first feeding segment 232a of the second feeding portion 232 may also be formed on the second surface. Accordingly, a conductive via connected over the first surface and the second surface of the insulating plate 205 may be omitted. The second feeding portion 232 may include the first feeding segment 232a, the third feeding segment 232c, the fourth feeding segment 232d, the fifth feeding segment 232e, and the sixth feeding segment 232f, and may not include the second feeding segment 232b.

In the disclosure, an injection product used to describe embodiments may include the substrate portion 201 and the support portion 202. In addition to the substrate portion, for the substrate portion 201, a substrate area, a dielectric substrate, a substrate injection portion, a first injection product, a substrate structure, an upper substrate portion, an upper patch portion, a patch area, a radiation portion, and/or a term having the same technical/structural meaning thereto may be used. In addition to the support portion, for the support portion 202, a support area, a pillar portion, a pillar injection portion, a support injection portion, a second injection portion, a support structure, a feed structure, a feeding area, and/or a term having the same technical/structural meaning thereto may be used. A patch used to describe embodiments in the disclosure may indicate the metal pattern 215 of the non-conductive substrate 210. In addition to the metal pattern, for the metal pattern 215, a conductive pattern, a metal pattern, a conductive portion, a metal area, a plating portion, a metal portion, a radiation pattern, a radiation area, and/or a term having the same technical/structural meaning thereto may be used.

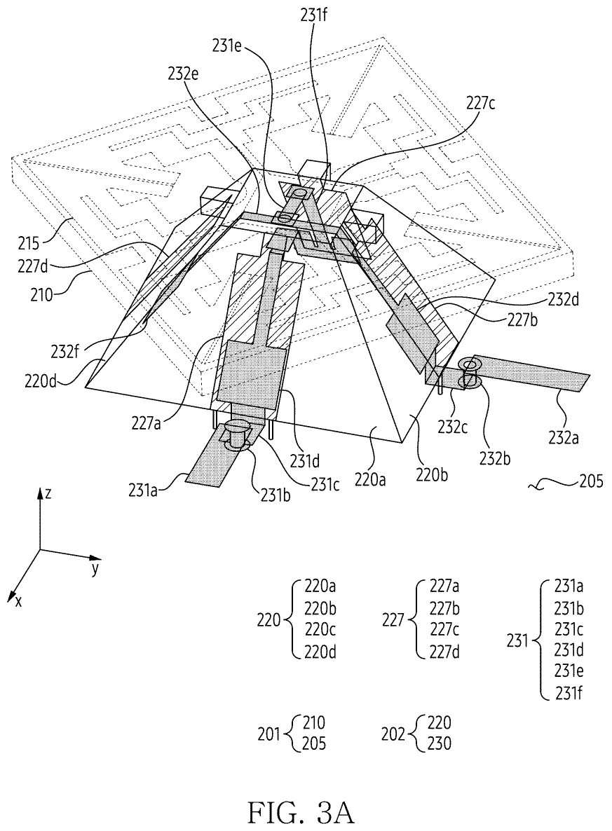

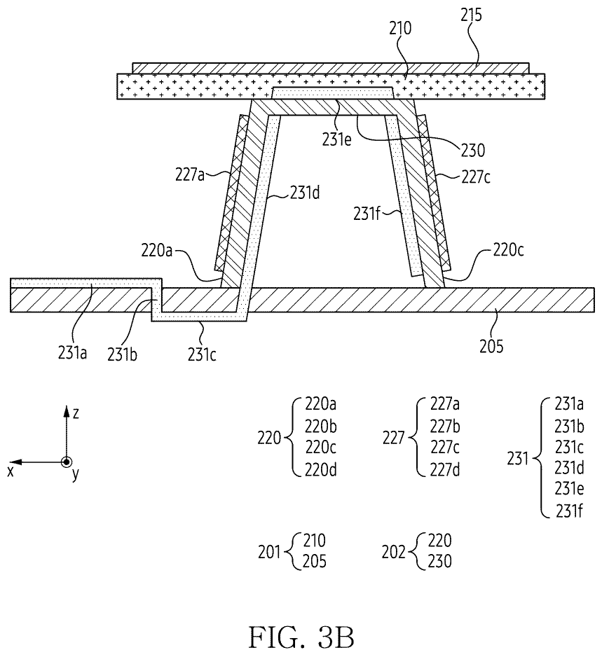

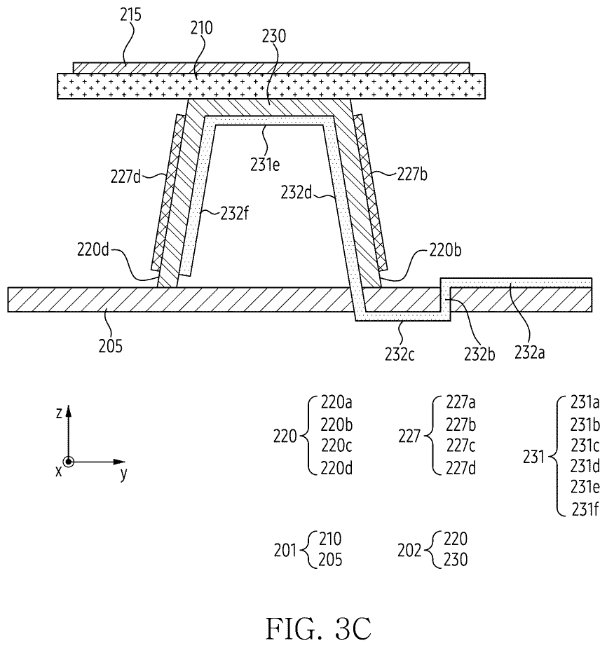

FIGS. 3A to 3C indicate another example of a radiation structure for a dipole antenna according to various embodiments of the disclosure. In FIGS. 2A to 2C, a shape in which side areas 220 of a support portion 202 having a quadrangular pillar shape are disposed substantially perpendicular to a surface (e.g., an xy plane) of an insulating plate 205 and/or a surface (e.g., the xy plane) of a non-conductive substrate 210 was described. In FIGS. 3A to 3C, with respect to the antenna element 200 of FIGS. 2A to 2C, an example in which the side areas 220 are inclined with respect to the surface (e.g., the xy plane) of the insulating plate 205 is described.

Referring to FIG. 3A, a perspective view of the antenna element 200 is illustrated. The antenna element 200 may include a radiation structure. The radiation structure may be disposed over a surface of the insulating plate 205. The radiation structure may include a substrate portion 201. The substrate portion may include a non-conductive substrate 210 and a metal pattern 215 formed on the non-conductive substrate 210. The radiation structure may include a support portion 202. The support portion 202 may include a plurality of side areas 220 and a feeding area 230.

According to an embodiment, at least a portion (e.g., a fourth feeding segment 231d, a sixth feeding segment 231f, or a sixth feeding segment 232f) of a feeding portion (e.g., a first feeding portion 231, or a second feeding portion 232) is disposed on an inner surface of each side areas (e.g., a first side area 220a, a second side area 220b, a third side area 220c, and a fourth side area 220d) of the side areas 220, and a ground area (e.g., a first ground area 227a, a second ground area 227b, a third ground area 227c, and a fourth ground area 227d) is disposed on an outer surface. An additional plating process may be required to form a pattern (hereinafter, a feeding pattern) (e.g., the fourth feeding segment 231d, a fourth feeding segment 232d, a fifth feeding segment 232e, the sixth feeding segment 231f, and the sixth feeding segment 232f) configured with metal on an inner surface (i.e., an inner surface of a side area) in a structure of the support portion 202. In order to easily form the feeding pattern, it may be required that a volume of a space formed through the side areas 220 of the support portion 202 is sufficient. The support portion 202 may be used to support the substrate portion 201 (e.g., the non-conductive substrate 210) from the insulating plate 205. The support portion 202 may include a structure having a predetermined inclination. Due to the predetermined inclination, a width of an area where the side areas are coupled to the insulating plate 205 may be different from a width of the feeding area 230. For example, the width of the area where the side areas are coupled to the insulating plate 205 may be wider than the width of the feeding area 230. For example, a shape of the support portion 202 may be a frustum of quadrangular pyramid. As an internal space of the support portion 202 is sufficiently secured, a feeding pattern corresponding to a signal line may be formed more accurately and stably (e.g., low process error) on the inner surface of the side area.

Referring to FIG. 3B, a cross-section of the antenna element 200 of FIG. 3A in a direction (e.g., in a −y axis direction) is illustrated. The first feeding portion 231 may be formed along at least one side area (e.g., the first side area 220a, or the third side area 220c) among the plurality of side areas 220 of the support portion 202, and the feeding area 230. For description regarding feeding segments configuring the first feeding portion 231, FIG. 2B may be referred to. The fourth feeding segment 231d of the first feeding portion 231 may be disposed over a surface (e.g., an inner surface) of the first side area 220a among the plurality of side areas 220. The sixth feeding segment 231f of the first feeding portion 231 may be disposed over a surface (e.g., an inner surface) of the third side area 220c among the plurality of side areas 220. Since the fourth feeding segment 231d and the sixth feeding segment 231f are formed along a surface of a corresponding side area, the fourth feeding segment 231d and the sixth feeding segment 231f may be disposed to have a predetermined inclination with respect to the insulating plate 205.

Referring to FIG. 3C, a cross-section of the antenna element 200 of FIG. 3A in a direction (e.g., in a −x axis direction) is illustrated. The second feeding portion 232 may be formed along at least one side area (e.g., the second side area 220b, or the fourth side area 220d) among the plurality of side areas 220 of the support portion 202, and the feeding area 230. For description regarding feeding segments configuring the second feeding portion 232, FIG. 2C may be referred to. The fourth feeding segment 232d of the second feeding portion 232 may be disposed over a surface (e.g., an inner surface) of the second side area 220b among the plurality of side areas 220. The sixth feeding segment 232f of the second feeding portion 232 may be disposed over a surface (e.g., an inner surface) of the fourth side area 220d among the plurality of side areas 220. Since the fourth feeding segment 232d and the sixth feeding segment 232f are formed along a surface of a corresponding side area, the fourth feeding segment 232d and the sixth feeding segment 232f may be disposed to have a predetermined inclination with respect to the insulating plate 205.

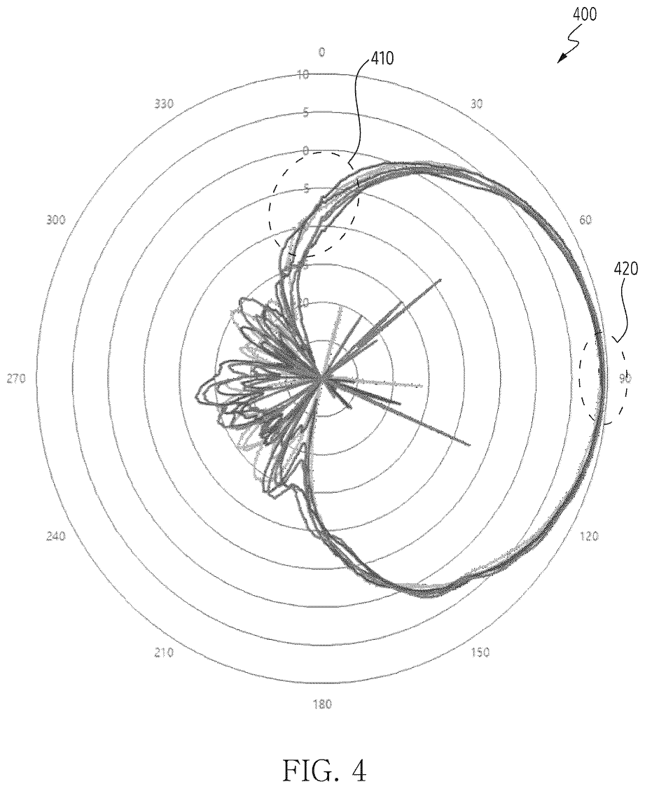

FIG. 4 indicates an example of a radiation pattern of an antenna module using a dipole antenna according to an embodiment of the disclosure. An electronic device according to embodiments may include an antenna array. The antenna array may include a plurality of sub-arrays. Each sub-array of the plurality of sub-arrays may include antenna elements. The radiation structure described in FIGS. 2A to 2C may correspond to the antenna element 200 of FIG. 2A among the plurality of antenna elements. Hereinafter, FIG. 4 indicates an example of a radiation pattern of a sub-array using the antenna element 200 of FIG. 2A.

In order to support various services and meet a high data rate for the services, support for wideband is required. However, compared to a narrow-band antenna, a wideband antenna is difficult to provide a constant beam width for each frequency. A beam squint may be used as an index indicating beamforming performance. The beam squint refers to a phenomenon in which a beam direction of an antenna is directed differently from a radiation direction of the antenna. The beam squint may occur in an array antenna in which a plurality of antenna elements are concentrated. For example, the beam squint may occur as each antenna element has a different position and phase components of signals radiated from each antenna element are different. For example, signals radiated from a sub-array may be coupled to antenna elements adjacent to the sub-array, and re-radiation occurs at the antenna elements, an originally intended beam direction and an actual beam direction may become different. Due to the beam squint, a directivity performance of the antenna may deteriorate, and a gain of the antenna may be reduced.

Referring to FIG. 4, a graph 400 indicates radiation patterns of different sub-arrays of the array antenna. Each antenna element of the sub-arrays may be the antenna element 200 of FIGS. 2A to 2C and 3A to 3C. Coupling feeding through the feeding area 230 of the support portion 202 and a metal pattern 215 formed on a surface of the non-conductive substrate 210 may allow the antenna element 200 to operate as the dipole antenna. Although not illustrated in FIG. 4, a radiator of a microstrip patch may be used for comparison with the dipole antenna including the antenna element 200 according to embodiments of the disclosure. For a sub-array including the microstrip patch, a radiation pattern may vary in a grating lobe according to a position of the sub-array. Due to a difference in the radiation pattern between the sub-arrays, a beam squint may be identified. For the sub-arrays including the microstrip patch, a standard deviation of a peak gain is about 0.37. Referring to a first area 410 of the graph 400, it may be identified that the radiation patterns of the sub-arrays have similar shapes. Through the dipole antenna according to embodiments of the disclosure, it may be identified that the beam squint is reduced. Referring to a second area 420 of the graph 400, it may be identified that a standard deviation of the peak gain between the sub-arrays is about 0.16. Through the dipole antenna according to embodiments of the disclosure, it may be identified that a deviation of the peak gain between the sub-arrays decreases.

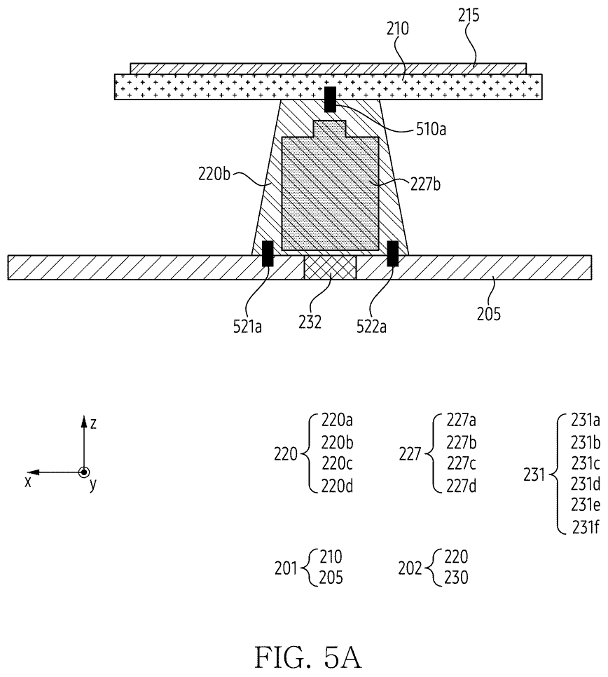

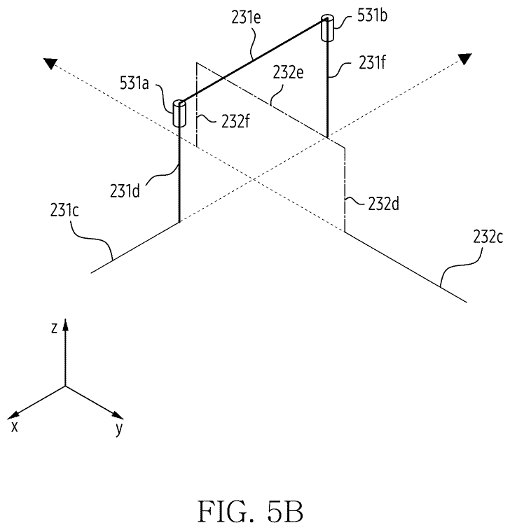

FIG. 5A indicates a cross-section of a radiation structure for a dipole antenna according to an embodiment of the disclosure. FIG. 5A indicates a cross-section of a radiation structure corresponding to the antenna element 200 of FIGS. 3A to 3C viewed in a direction (e.g., in a −y axis direction).

Referring to FIG. 5A, a substrate portion 201 may be disposed over a support portion 202. A non-conductive substrate 210 of the substrate portion 201 may be disposed over the support portion 202. At least one upper via may be used such that the non-conductive substrate 210 is stably coupled to the support portion 202. For example, an upper via 510a may be disposed to connect a second side area 220b of the support portion 202 or a feeding area 230 to the non-conductive substrate 210. Although not illustrated in FIG. 5A, the antenna element 200 may include a plurality of upper vias. The plurality of upper vias may be used to couple the substrate portion 201 and the support portion 202.

The support portion 202 may be disposed over a surface of an insulating plate 205. The support portion 202 may include a plurality of side areas 220 and the feeding area 230. The plurality of side areas 220 may include a first side area 220a, a second side area 220b, a third side area 220c, and a fourth side area 220d. In FIG. 5A, in order to indicate a relationship in a stacking direction (e.g., a +z axis direction), the second side area 220b and another side area are not illustrated. The second side area 220b may be coupled to the insulating plate 205. For stable coupling between the second side area 220b of the support portion 202 and the insulating plate 205, at least one lower via may be used. For example, each of a first lower via 521a and a second lower via 521b may be disposed to connect the insulating plate 205 and a partial area (e.g., groove) of the second side area 220b. Although not illustrated in FIG. 5A, the antenna element 200 may include a plurality of lower vias. The plurality of lower vias may be used to couple the support portion 202 and the insulating plate 205. According to an embodiment, the plurality of lower vias may be used such that a ground area (e.g., a second ground area 227b) is connected to a ground of the insulating plate 205. The lower vias may be conductive vias.

In FIG. 5A, an example in which two lower vias are disposed to connect a side area and the insulating plate 205 has been described, but embodiments of the disclosure are not limited thereto. For example, two lower vias may be disposed in a side area, but one lower via may be disposed in another side area. For another example, among the antenna elements of the sub-array, an antenna element may include two lower vias for each side area, and another antenna element may include one lower vias for each side area.

In FIG. 5A, an example in which vias are used for stable coupling between a substrate (e.g., the non-conductive substrate 510) of a dielectric material and a dielectric structure (e.g., the support portion 202) or for coupling between the dielectric structure and the insulating plate 205 has been described. Meanwhile, vias may be used as a portion of a feeding line as well as a connection between structures. For example, as described in FIGS. 2B, 2C, 3B, and 3C, a feeding line extending from a conductive pattern may be formed by penetrating the insulating plate 205 through a conductive via (e.g., a second feeding segment 231b, or a second feeding segment 232b).

A via (e.g., the upper via 510a, the first lower via 521a, or the second lower via 521b) used to describe embodiments in the disclosure is used for connecting two structures, and, in addition to the via, a connection unit, a connecting portion, a conductive via, a vertical via, a connection area, and/or a term having the same technical/structural meaning thereto, may be used.

FIG. 5B indicates an example of feeding lines of a radiation structure (e.g., antenna element 200 of FIGS. 2A to 2C) for a dipole antenna according to an embodiment of the disclosure.

Referring to FIG. 5B, the feeding lines may include a first feeding line (e.g., a first feeding portion 231) for a first polarization and a second feeding line (e.g., a second feeding portion 232) for a second polarization. The first polarization and the second polarization may be substantially perpendicular. For example, the first polarization may be a V-polarization, and the second polarization may be an H-polarization. For example, the first polarization may be a (+) about 45 degrees polarization, and the second polarization may be a (−) about 45 degrees polarization.

The support portion 202 may be a dielectric. The support portion 202 may be a three-dimensional figure composed of the dielectric. The support portion 202 may include the plurality of side areas 220 and the feeding area 230 connected to the side areas 220. The feeding area 230 may be supported by the side areas 220 and may be disposed to face in a direction (e.g., the +z axis direction). As illustrated in FIGS. 2A to 3C, the feeding area 230 may be disposed close to the substrate portion 201. The first feeding portion 231 may be disposed such that at least a portion (e.g., a fifth feeding segment 231e) of the first feeding portion 231 passes through the feeding area 230. The second feeding portion 232 may be disposed such that at least a portion (e.g., a fifth feeding segment 232e) of the second feeding portion 232 passes through the feeding area 230. However, signal lines of different polarizations may be disposed to have different heights (e.g., based on a z axis direction) so that performance degradation is not caused by overlapping. For example, a height at which at least a portion of the first feeding portion 231 is disposed along the feeding area 230 of the support portion 202 may be higher than a height at which at least a portion of the second feeding portion 232 is disposed along the feeding area 230 of the support portion 202. For example, a height (e.g., a position on the z-axis from the insulating plate 205) of the fifth feeding segment 231e of the first feeding portion 231 may be higher than a height (e.g., a position on the z-axis from the insulating plate 205) of the fifth feeding segment 232e of the second feeding portion 232.

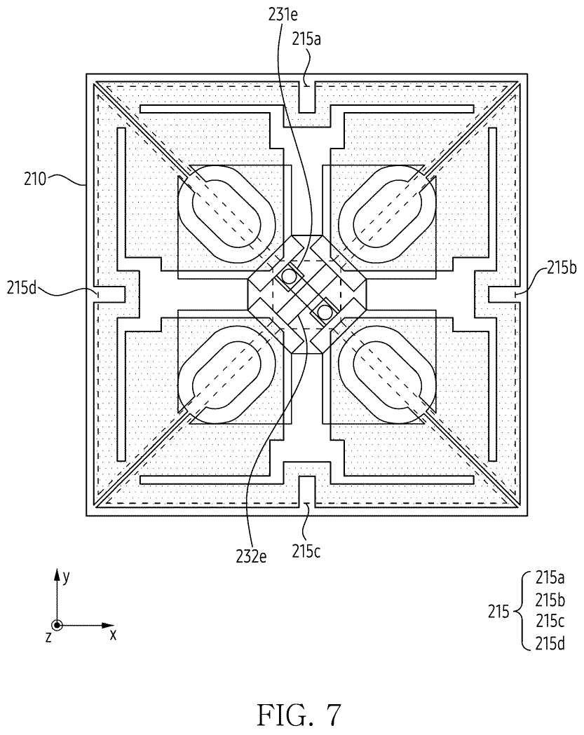

Signals provided through the first feeding portion 231 and signals provided through the second feeding portion 232 may have different phases. In this case, a difference between the height of the fifth feeding segment 231e and the height of the fifth feeding segment 232e may be used as a balun for a folded-dipole (e.g., at least a portion of a metal pattern 215 of FIG. 7), which will be described later. While the dipole antenna corresponding to the metal pattern 215 is equilibrium circuitry, feeding points (e.g., the fifth feeding segment 231e and the fifth feeding segment 232e) correspond to unbalanced circuitry. Feeding patterns (e.g., a fourth feeding segment 231d, the fifth feeding segment 231e, a sixth feeding segment 231f, a fourth feeding segment 232d, the fifth feeding segment 232e, and a sixth feeding segment 232f) formed along a surface of the support portion 202 may be understood as balun circuitry for a dipole antenna in a wideband.

The feeding area 230 may include a first surface (e.g., an outer surface) facing a direction (e.g., the +z axis) and a second surface (e.g., an inner surface) facing a direction (e.g., the −z axis) opposite to the direction. At least a portion (e.g., the fifth feeding segment 231e) of the first feeding portion 231 may be formed along the first surface of the feeding area 230. At least a portion (e.g., the fifth feeding segment 232e) of the second feeding portion 232 may be formed along the second surface of the feeding area 230. To implement different heights in the feeding area 230 of the support portion 202, a conductive via may be used. Since a portion (e.g., the fourth feeding segment 231d, or the sixth feeding segment 231f) of the first feeding portion 231 is disposed along an inner surface of the support portion 202, conductive vias may be used for the feeding pattern to be positioned on the first surface of the feeding area 230. For example, the first feeding portion 231 may include a first conductive via 531a for connecting the fourth feeding segment 231d and the fifth feeding segment 231e. The first feeding portion 231 may include a second conductive via 531b for connecting the fifth feeding segment 231e and the sixth feeding segment 231f. Each of the first conductive via 531a and the second conductive via 531b may be disposed to penetrate the feeding area 230.

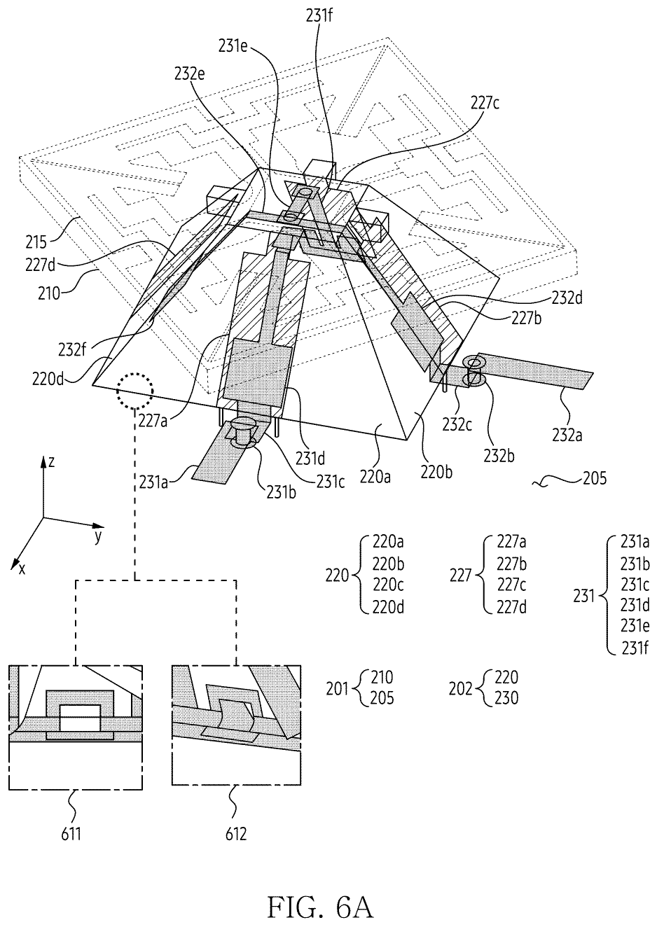

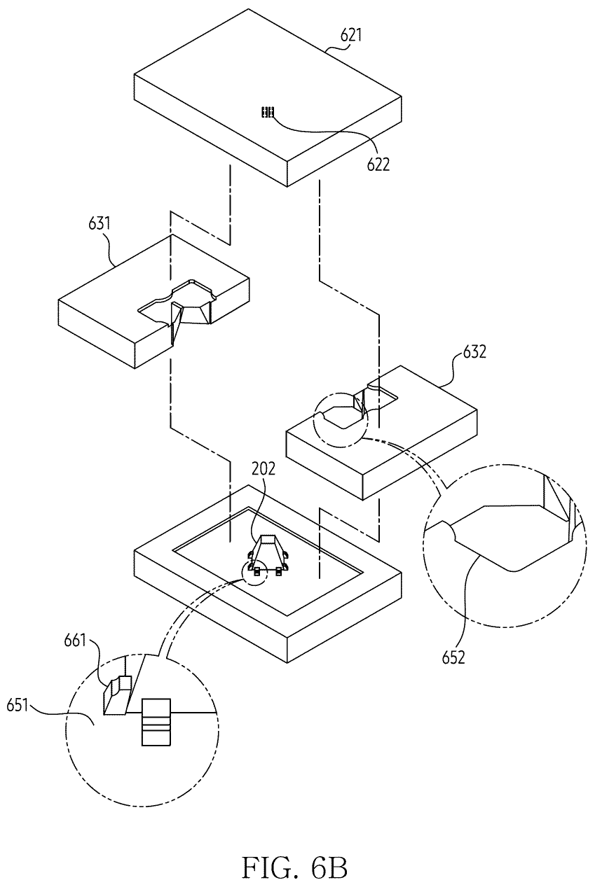

FIG. 6A indicates examples of a via for a radiation structure (e.g., the antenna element 200 of FIG. 3A) for a dipole antenna according to an embodiment of the disclosure. The via may be used for coupling between a support portion 202 and an insulating plate 205. For example, the via may include the lower via illustrated in FIG. 5A.

Referring to FIG. 6A, in the antenna element 200 of FIG. 3A, examples of a lower via for coupling between a first side area 220a and the insulating plate 205 are illustrated.

For example, an antenna module including the antenna element 200 may include a connection structure 611 (e.g., a groove, or an opening) for coupling between the first side area 220a and the insulating plate 205. For coupling between the first side area 220a and the insulating plate 205, a lower via 612 may be disposed in the connection structure 611. For example, a shape of the connection structure 611 may be a three-dimensional figure having a surface perpendicular to a direction (e.g., a +y axis and/or a −y axis). Instead of a commonly used circular via, a shape of the lower via 612 may be an angled shape (e.g., a quadrangular pillar, or a polygonal pillar with an angled edge). Through the lower via 612, when manufacturing the support portion 202 through a dielectric, robustness of a wetting surface (a contact surface) may be secured. An example of a manufacturing process using the via having the angled shape will be described in detail with reference to FIG. 6B.

FIG. 6B indicates an example of a method for generating a radiation structure (e.g., the antenna element 200 of FIG. 3A) for a dipole antenna according to an embodiment of the disclosure. For manufacturing a dielectric structure in the antenna module including the antenna element 200, an injection molding technique may be used. The injection molding is a process of making a product of a desired shape by injecting hot plastic into a mold. The process may be used to mass-produce a plastic product. According to an embodiment, in the antenna element 200, a non-conductive substrate 210 of the substrate portion 201 and the support portion 202 may be dielectrics (e.g., plastic) and are integrally formed.

Referring to FIG. 6B, instead of coupling the non-conductive substrate 210 after the support portion 202 is formed, the support portion 202 and the non-conductive substrate 210 may be integrally formed. A plurality of cores may be used to form the non-conductive substrate 210 and the support portion 202. A core refers to a mold frame for forming a space of an injection product in injection molding. In an injection molding process, a sliding core may be used to prevent undercut from occurring during injection. For example, the plurality of cores may include an upper core 621, a first sliding core 631, and a second sliding core 632. The upper core 621 may include a connection structure 622 for a via (e.g., an upper via 510a). The connection structure 622 may be used for coupling between the non-conductive substrate 210 and the support portion 202. A movement direction of the first sliding core 631 and a movement direction of the second sliding core 632 may be limited. For example, the first sliding core 631 may move in a direction (e.g., the +y axis direction). The second sliding core 632 may move in a direction (e.g., the −y axis direction). Since the first sliding core 631 and the second sliding core 632 does not move in the +z axis direction or the −z axis direction, respectively, but moves only in a direction in an xy plane, undercut may not occur during injection.

Referring to an enlarged view 651, the support portion 202 corresponding to the injection product may include a connection structure 661 for a lower via (e.g., the lower via 612) in partial areas. Referring to the enlarged view 651, the second sliding core 632 may be configured to form an injection product up to a boundary portion where the first sliding core 631 and the second sliding core 632 meet. The connection structure 661 may be positioned in the boundary portion 652. In other words, the first sliding core 631 may contact the connection structure 661, and the connection structure 661 may contact the second sliding core 632. Through the connection structure 661 corresponding to a quadrangular via, robustness between contact surfaces may be secured in the molding process using the sliding core.

FIG. 7 indicates an example of a metal pattern for a dipole antenna according to an embodiment of the disclosure. A metal pattern 215 illustrated in FIG. 7 is exemplary, and the metal pattern 215 of FIG. 7 is not interpreted as limiting a shape of a radiator for the dipole antenna according to embodiments of the disclosure. An electronic device according to embodiments may include an antenna array. The antenna array may include a plurality of antenna elements. The radiation structure described in FIGS. 2A to 2C may correspond to an antenna element 200 among the plurality of antenna elements. The antenna element 200 may be used as the dipole antenna. For description regarding the antenna element 200, FIGS. 2A to 2C and 3A to 3C may be referred to.

Referring to FIG. 7, a substrate portion 201 of the antenna element 200 may include a non-conductive substrate 210 and the metal pattern 215 formed on the non-conductive substrate 210. The metal pattern 215 may be configured to radiate signals excited based on coupling feeding in the feeding area 230 described through FIGS. 2A to 2C, 3A, to 3C, 4, 5A, and 5B.

The metal pattern 215 may include a plurality of folded-dipoles. For example, the metal pattern 215 may include a first pattern part 215a, a second pattern part 215b, a third pattern part 215c, and a fourth pattern part 215d. A folded-dipole indicates a shape in which a loop is formed to connect both ends of the dipoles. The folded-dipole may be configured to radiate signals coupled through a first feeding portion 231 and/or a second feeding portion 232. For example, the first pattern part 215a may be a radiator having a first end portion of a fifth feeding segment 232e of the second feeding portion 232 as a feeding point. A loop of the first pattern part 215a may include a loop from the feeding point to a first end portion of a fifth feeding segment 231e of the first feeding portion 231. For example, the second pattern part 215b may be a radiator having a second end portion (a portion opposite to the first end portion) of the fifth feeding segment 231e of the first feeding portion 231 as a feeding point. A loop of the second pattern part 215b may include a loop from the feeding point to the first end portion of the fifth feeding segment 232e of the second feeding portion 232. For example, the third pattern part 215c may be a radiator having a second end portion (a portion opposite to the first end portion) of the fifth feeding segment 232e of the second feeding portion 232 as a feeding point. A loop of the third pattern part 215c may include a loop from the feeding point to the second end portion of the fifth feeding segment 231e of the first feeding portion 231. For example, the fourth pattern part 215d may be a radiator having the first end portion of the fifth feeding segment 231e of the first feeding portion 231 as a feeding point. A loop of the fourth pattern part 215d may include a loop from the feeding point to the second end portion of the fifth feeding segment 232e of the second feeding portion 232. A disposition of the first feeding portion 231 and the second feeding portion 232 in the side areas 220 of the support portion 202 and the feeding area 230, may be configured to form balun circuitry for the folded-dipole. The first feeding portion 231 and the second feeding portion 232 may have different electrical lengths so that phases of a start point (e.g., a feeding point of the first feeding portion 231) and an end point (e.g., a feeding point of the second feeding portion 232) of a loop of each folded dipole coincide.

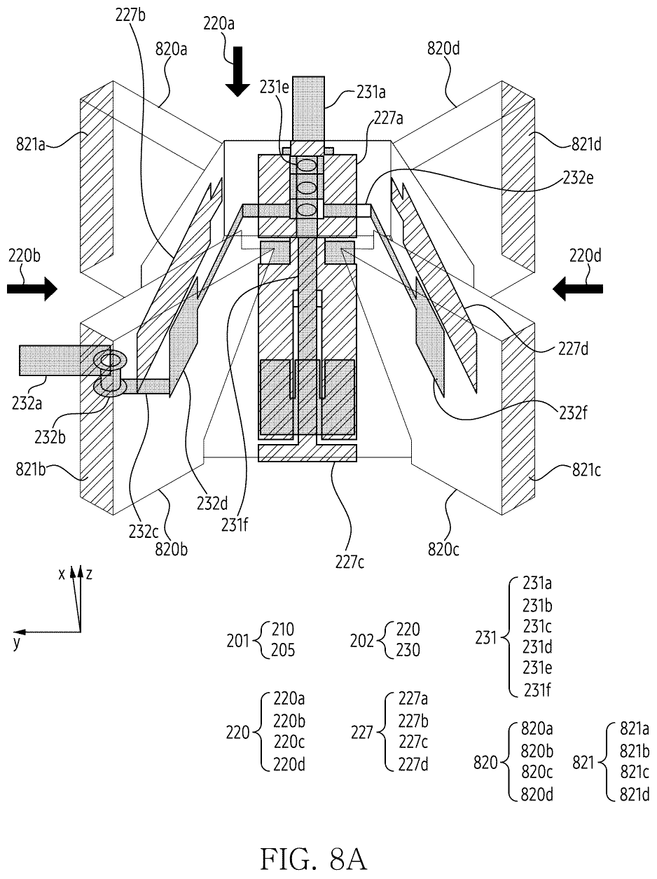

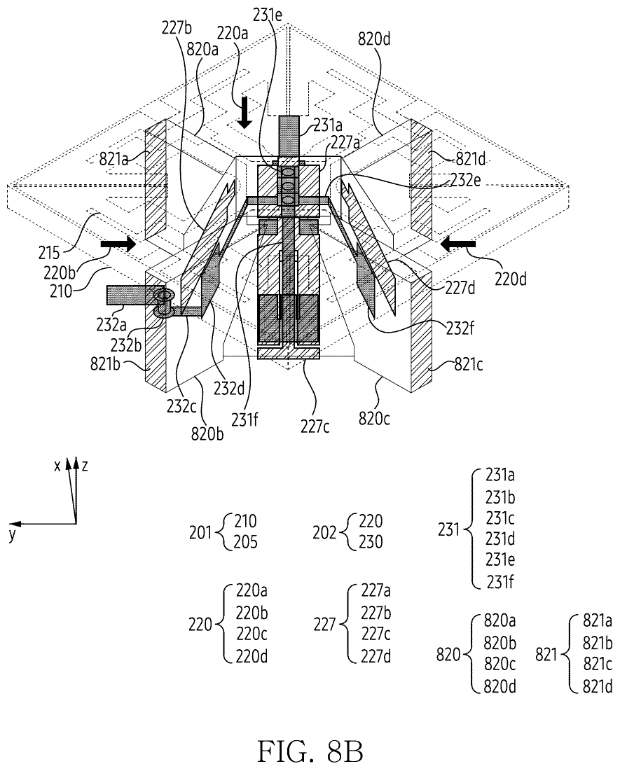

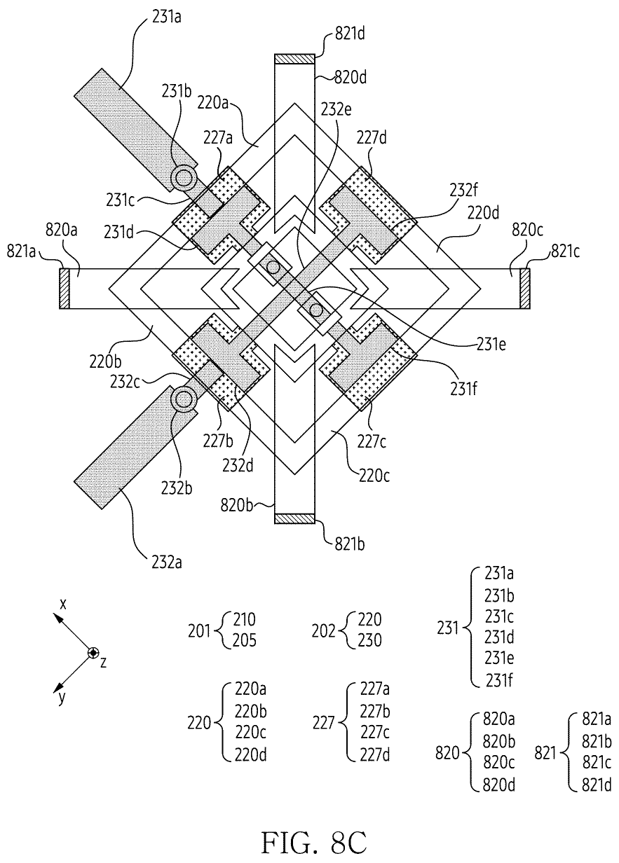

FIGS. 8A to 8C indicate an example of an antenna element (e.g., the antenna element 200 of FIGS. 3A to 3C) including a pillar structure for beamforming control according to various embodiments of the disclosure. In FIGS. 8A and 8B, a perspective view of the antenna element 200 including the pillar structure is illustrated. In FIG. 8C, a top plan view of the antenna element 200 including the pillar structure is illustrated. In order to more clearly indicate pillar structures in three-dimensional space, FIG. 8A indicates the antenna element 200 in which a non-conductive substrate 210 and a conductive pattern 215 of the antenna element 200 are omitted, and FIG. 8B indicates the antenna element 200 including the pillar structure of FIG. 8A, the non-conductive substrate 210, and the conductive pattern 215. Descriptions regarding FIG. 8A may be applied to FIG. 8B in the same manner. FIG. 8C is a top plan view corresponding to FIG. 8A.

Referring to FIGS. 8A, 8B, and 8C, a substrate portion 201 may include the non-conductive substrate 210 and the metal pattern 215. As described in FIG. 7, the metal pattern 215 may include one or more folded-dipoles (e.g., a first pattern part 215a, a second pattern part 215b, a third pattern part 215c, and a fourth pattern part 215d). A general dipole antenna may form a symmetrical radiation pattern with respect to a feeding point. In order to adjust a direction and a beam width of the radiation pattern, an additional pillar structure may be used.

According to an embodiment, the antenna element (e.g., the antenna element 200 of FIGS. 3A to 3C) may include a plurality of pillar structures 820. The plurality of pillar structures 820 may include a first pillar structure 820a, a second pillar structure 820b, a third pillar structure 820c, and a fourth pillar structure 820d. According to an embodiment, the plurality of pillar structures 820 may be disposed below a dipole antenna, that is, the non-conductive substrate 210. For example, the plurality of pillar structures 820 may be disposed between the non-conductive substrate 210 and an insulating plate 205. According to an embodiment, each pillar structure of the plurality of pillar structures 820 may be used to support the non-conductive substrate 210. Each pillar structure of the plurality of pillar structures 820 may be disposed such that the non-conductive substrate 210 maintains a constant distance spaced apart from the insulating plate 205.

According to an embodiment, each pillar structure of the plurality of pillar structures 820 may be a dielectric and may be coupled to a support portion 202. For example, each pillar structure of the plurality of pillar structures 820 may be coupled to a periphery area between side areas of the support portion 202. The first pillar structure 820a may be coupled to a periphery area between a first side area 220a and a second side area 220b. The second pillar structure 820b may be coupled to a periphery area between the second side area 220b and a third side area 220c. The third pillar structure 820c may be coupled to a periphery area between the third side area 220c and a fourth side area 220d. The fourth pillar structure 820d may be coupled to a periphery area between the fourth side area 220d and the first side area 220a.

According to an embodiment, each pillar structure of the plurality of pillar structures 820 may include a conductive portion 821. For example, the first pillar structure 820a may include a first conductive portion 821a. For example, the second pillar structure 820b may include a second conductive portion 821b. For example, the third pillar structure 820c may include a third conductive portion 821c. For example, the fourth pillar structure 820d may include a fourth conductive portion 821d. The conductive portion may be used to adjust a pattern of a beam formed in a folded-dipole.

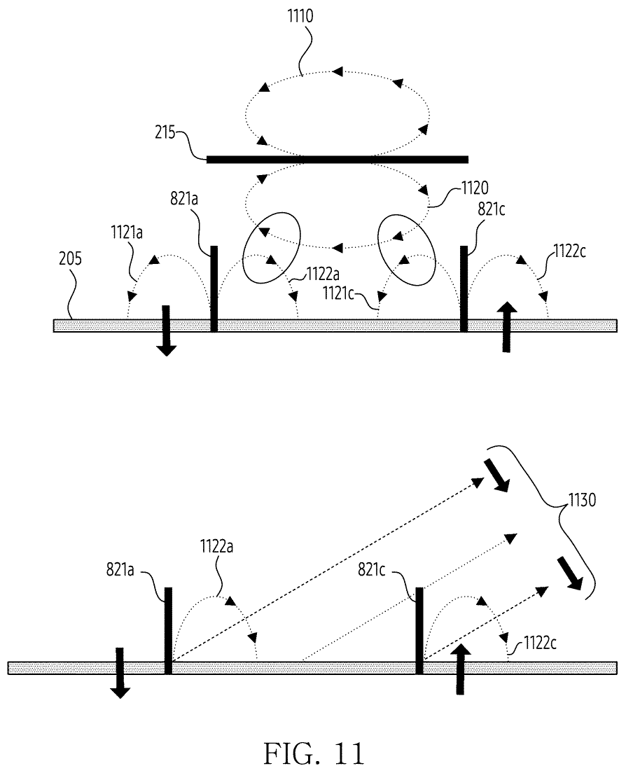

According to an embodiment, beamforming elements (e.g., a beam width, or a beam gain) may be controlled based on a shape of a conductive portion of each pillar structure of the plurality of pillar structures 820. For example, the beamforming elements may be controlled based on a length of the conductive portion in a height direction (e.g., a +z axis direction). In a case that the pillar structure is a dielectric, the conductive portion may be used to control a radiation pattern of the metal pattern 215. According to an embodiment, the beamforming elements (e.g., the beam width, or the beam gain) may be controlled based on a disposition of the plurality of pillar structures 820. For example, according to a distance between the first pillar structure 820a and the third pillar structure 820c, a beam pattern of the metal pattern 215 may vary. As an example, as the distance between the first pillar structure 820a and the third pillar structure 820c is narrowed, a beam width of the beam pattern may be narrowed and a beam gain in a boresight may increase. For example, according to a distance between the second pillar structure 820b and the fourth pillar structure 820d, the beam pattern of the metal pattern 215 may vary. For example, as the distance between the second pillar structure 820b and the fourth pillar structure 820d is narrowed, a beam width of the beam pattern may be narrowed and a beam gain in the boresight may increase. A technical principle for controlling a beam pattern of the dipole antenna will be described in detail with reference to FIG. 11.

In FIGS. 8A to 8C, an example in which a conductive portion, which is a metal, is formed on a pillar structure configured with a dielectric has been described, but embodiments of the disclosure are not limited thereto. A metal pillar structure may be used as a technical principle for controlling beamforming elements in FIG. 11 to be described later. For example, instead of the pillar structure and the conductive portion separately formed in each pillar structure, the metal pillar structure may be used to control the beamforming element.

For a pillar structure (e.g., the first pillar structure 820a, the second pillar structure 820b, the third pillar structure 820c, or the fourth pillar structure 820d) used to describe embodiments in the disclosure, a pillar structure, a pillar portion, an additional pillar portion, an additional structure, an additional structure body, a pillar structure, a monopole-shaped structure, a radiation control structure, a radiation pattern control structure, a beam pattern control structure, a beam control structure, a monopole-like shape, a monopole-like structure, and/or a term having the same technical/structural meaning may be used.

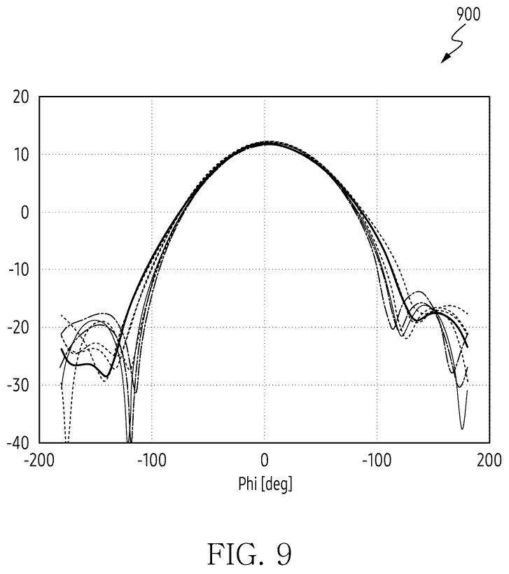

FIG. 9 indicates an example of performance of an antenna element (e.g., the antenna element 200 of FIGS. 3A to 3C) including a pillar structure for beamforming control according to an embodiment of the disclosure. A factor for controlling beamforming may include a beam width and/or a gain. In FIG. 9, an antenna element 200 including the pillar structures (e.g., the first pillar structure 820a, the second pillar structure 820b, the third pillar structure 820c, and the fourth pillar structure 820d) of FIGS. 8A to 8C is illustrated.

Referring to FIG. 9, a graph 900 indicates a radiation pattern of a pillar structure for beamforming control. A horizontal axis of the graph 900 indicates an antenna direction (unit: degree) based on a boresight (or a front direction). A vertical axis of the graph 900 indicates an antenna gain (unit: decibel (dB)). The graph 900 indicates radiation patterns of the antenna element 200 for different cases according to a length of a conductive portion (e.g., a first conductive portion 821a, a second conductive portion 821b, a third conductive portion 821c, and a fourth conductive portion 821d) of the pillar structure for beamforming control, in a height direction (e.g., a z axis direction). It may be identified that as the conductive portion of the pillar structure is changed, a beam width and an antenna gain of the formed beam are changed. According to an embodiment, a beam width and an antenna gain of the beam may be determined based on the length of the conductive portion of the pillar structure in the height direction. For example, as the length of the conductive portion of the pillar structure increases, the beam width of the beam may be narrowed, and the antenna gain in the boresight may increase. For another example, as the length of the conductive portion of the pillar structure becomes shorter, the beam width of the beam may increase and the antenna gain in the boresight may decrease. A technical principle for the beam width and the antenna gain will be described in detail with reference to FIG. 11.

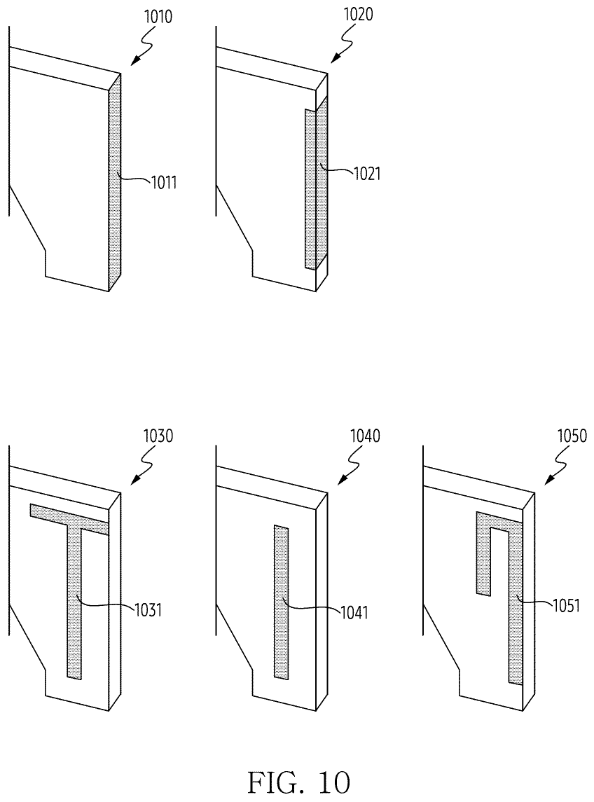

FIG. 10 indicates an example of a conductive portion (e.g., a first conductive portion 821a, a second conductive portion 821b, a third conductive portion 821c, or a fourth conductive portion 821d) of a pillar structure (e.g., a first pillar structure 820a, a second pillar structure 820b, a third pillar structure 820c, or a fourth pillar structure 820d) for beamforming control according to an embodiment of the disclosure.

Referring to FIG. 10, a first example 1010 indicates a conductive portion 1011 formed on an outer surface of the pillar structure. The outer surface may indicate a surface of the pillar structure that faces a direction opposite to a support portion (e.g., a support portion 202). A second example 1020 indicates a conductive portion 1021 formed on a plurality of surfaces of the pillar structure. The plurality of surfaces may include the outer surface and side surfaces of the outer surface. A third example 1030 indicates a conductive portion 1031 formed on a plurality of side surfaces of the pillar structure. The conductive portion 1031 may have a ‘T’ shape on each side surface of the pillar structure. A fourth example 1040 indicates a conductive portion 1041 formed on a plurality of surfaces of the pillar structure. The conductive portion 1041 may have an ‘I’ shape on each side surface of the pillar structure. A fifth example 1050 indicates a conductive portion 1051 formed on a plurality of side surfaces of the pillar structure. The conductive portion 1051 may have a ‘7’ shape on each side surface of the pillar structure.

Although various shapes are illustrated in FIG. 10, embodiments of the disclosure are not limited thereto. In addition to a shape illustrated in FIG. 10, if a conductive portion has a shape having a certain length in the height direction (e.g., the z axis direction), the conductive portion may be used to change a radiation pattern of a folded-dipole of a metal pattern 215.

In FIG. 10, a conductive portion formed on at least one surface of the pillar structure has been described as an example, but embodiments of the disclosure are not limited thereto. In addition to the pillar structure, a conductive portion may be additionally formed at an edge of an area where the support portion 202 and an insulating plate 205 are coupled. The additionally formed conductive portion and the conductive portion formed on the pillar structure may be used together to change the radiation pattern of the folded-dipole.

FIG. 11 is a diagram for describing a principle of beamforming control using a pillar structure (e.g., a first pillar structure 820a, a second pillar structure 820b, a third pillar structure 820c, or a fourth pillar structure 820d) according to an embodiment of the disclosure.

Referring to FIG. 11, a metal pattern 215, which is a radiator of a folded-dipole antenna, may form a first radiation pattern 1110 and a second radiation pattern 1120. The first radiation pattern 1110 and the second radiation pattern 1120 may be symmetrical with respect to a surface of the metal pattern 215. For example, the first radiation pattern 1110 may be formed in a direction (e.g., a +z axis direction) of the metal pattern 215. For example, the second radiation pattern 1120 may be formed in a direction opposite to the direction (e.g., a −z-axis direction) of the metal pattern 215.

A first parasitic pattern 1121a and a second parasitic pattern 1122a may be formed based on the second radiation pattern 1120 and a first conductive portion 821a of the first pillar structure 820a. A third parasitic pattern 1121c and a fourth parasitic pattern 1122c may be formed based on the second radiation pattern 1120 and a third conductive portion 821c of the third pillar structure 820c. Based on a side of the first conductive portion 821a and the third conductive portion 821c, each of the second parasitic pattern 1122a and the fourth parasitic pattern 1122c may be understood as a radiation pattern of an antenna element. A radiation pattern of an array antenna may be formed through reinforcement interference and offset interference according to a phase difference between radiation patterns of a plurality of antenna elements included in the array antenna. According to the same technical principle, the radiation pattern 1130 may be formed based on a phase difference between the second parasitic pattern 1122a and the fourth parasitic pattern 1122c. The radiation pattern 1130 may affect the final radiation pattern of the metal pattern 215 together with the first radiation pattern 1110 and the second radiation pattern 1120.

According to an embodiment, a distance between the first conductive portion 821a and the third conductive portion 821c affects a beam width of the final radiation pattern of the metal pattern 215. For example, like a beam having a narrow and high gain being formed as a spacing between elements in an array antenna is short, a beam width of the metal pattern 215 becomes narrower as a distance between the first conductive portion 821a and the third conductive portion 821c is short. Instead of narrowing the beam width, as the distance is shorter, a beam gain in a central direction (or boresight) may increase. In other words, as the distance is shorter, a sharp beam may be formed. As another example, as the distance between the first conductive portion 821a and the third conductive portion 821c increases, a wider beam may be formed. Instead of widening the beam width, the beam gain in the central direction may decrease.

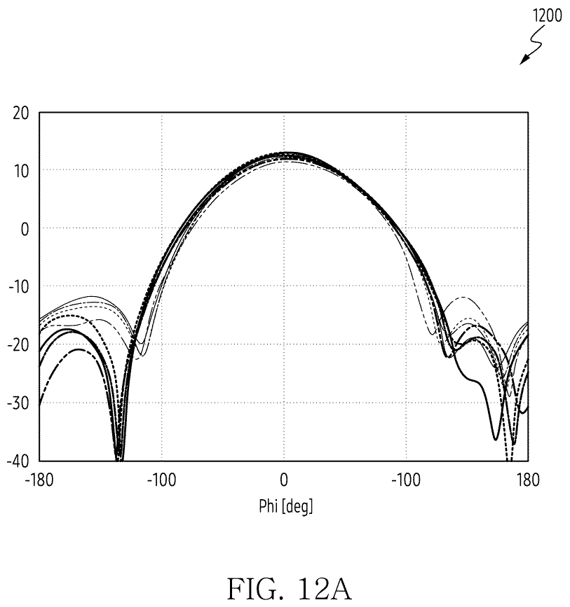

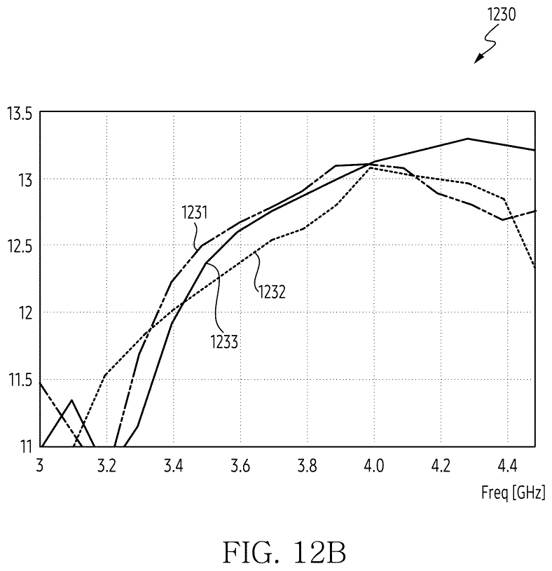

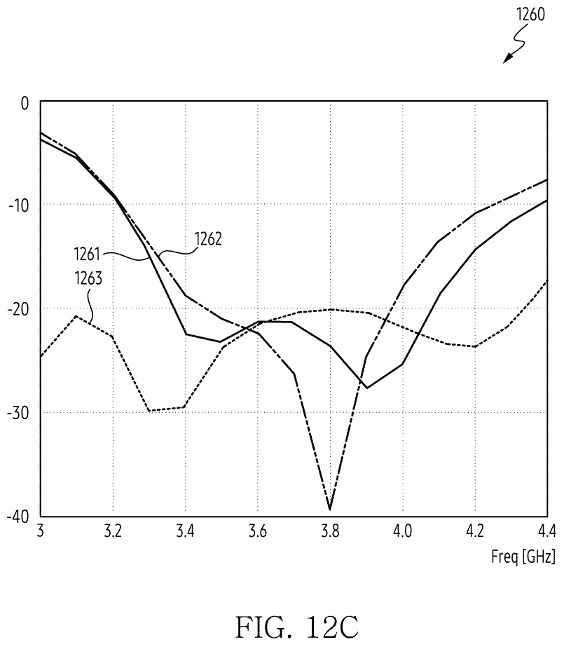

FIGS. 12A to 12C indicates examples of performance of a sub-array for a dipole antenna according to various embodiments of the disclosure. The sub-array may include a plurality of antenna elements (e.g., the antenna element 200 of FIGS. 3A to 3C).

Referring to FIG. 12A, a graph 1200 indicates radiation performance according to a presence or an absence of a pillar structure for beamforming control. A horizontal axis of the graph 1200 indicates an antenna direction (unit: degree) based on a boresight (or a front direction). A vertical axis of the graph 1200 indicates an antenna gain (unit: decibel (dB)). In the graph 1200, a solid line indicates a radiation pattern of a sub-array in which the pillar structure is disposed in each antenna element. In graph 1200, a dotted line indicates a radiation pattern of a sub-array in which the pillar structure is not disposed in each antenna element. When comparing the solid line and the dotted line, it may be identified that a beam width is different. For example, as the beam width becomes narrower, the antenna gain may increase in the front direction. For example, as the beam width increases, the antenna gain may decrease in the front direction.

Referring to FIG. 12B, a graph 1230 indicates an antenna gain according to a presence or an absence of a pillar structure for beamforming control. A horizontal axis of the graph 1230 indicates a frequency (unit: gigahertz (GHz)), and a vertical axis of graph 1230 indicates an antenna gain (unit: dB). In the graph 1230, a first line 1231 represents an antenna gain of a sub-array in which the pillar structure is disposed in each antenna element. A second line 1232 indicates an antenna gain of a sub-array in which the pillar structure is not disposed in each antenna element. A third line 1233 represents an antenna gain of a sub-array using a microstrip patch as a radiator. Referring to the first line 1231, the second line 1232, and the third line 1233, it may be identified that the antenna gain of the first line 1231 is higher than the antenna gain of another sub-array in a target frequency band (about 3.4 GHz to about 4 GHz).

Referring to FIG. 12C, a graph 1260 indicates an s-parameter of the sub-array in which the pillar structure for beamforming control is disposed. A horizontal axis of the graph 1260 indicates a frequency (unit: gigahertz (GHz)), and a vertical axis of the graph 1260 indicates a gain (unit: dB). In the graph 1260, a first line 1261 indicates a reflection coefficient (e.g., S₁₁) for a first polarization (e.g., a vertical polarization). A second line 1262 indicates a reflection coefficient (e.g., S₁₁) for a second polarization (e.g., a horizontal polarization). For example, a reflection coefficient threshold value for radiation may be about −14 dB. Referring to the first line 1261, a frequency value corresponding to −14 dB may be about 3.30 GHz or about 4.09 GHz. Referring to the second line 1262, a frequency value corresponding to −14 dB may be about 3.29 GHz or about 4.21 GHz. Referring to the first line 1261 and the second line 1262, it may be identified that a bandwidth of about 600 MHz or more is secured in the target frequency band (about 3.4 GHz to about 4 GHz). The third line 1263 indicates isolation (e.g., S₂₁) between the first polarization and the second polarization. When the isolation is less than or equal to a reference value (e.g., about −18 dB), polarization performance may be normally identified. Referring to the third line 1233, normal isolation performance may be identified in the target frequency band (about 3.4 GHz to about 4 GHz).

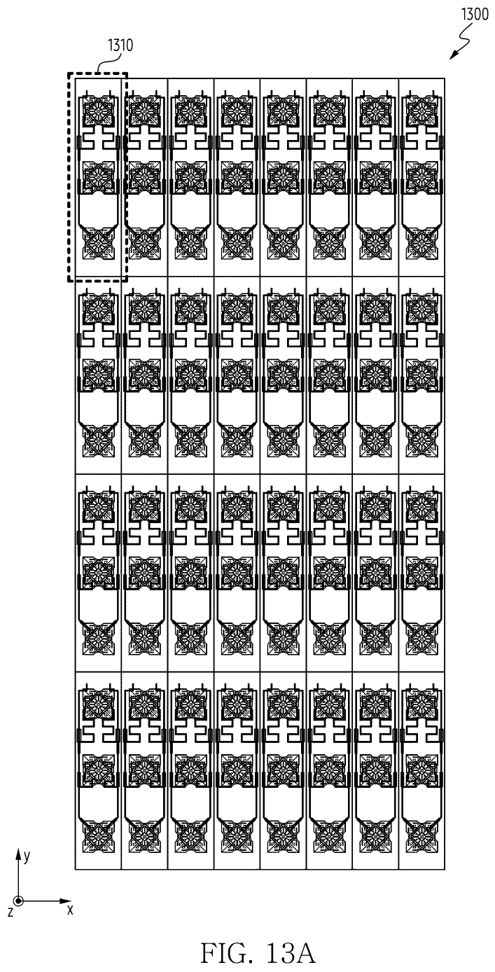

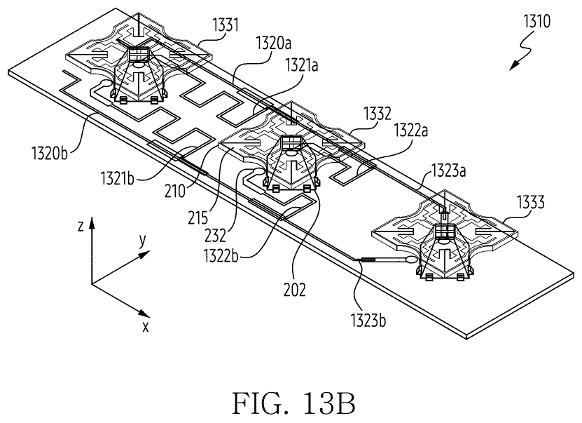

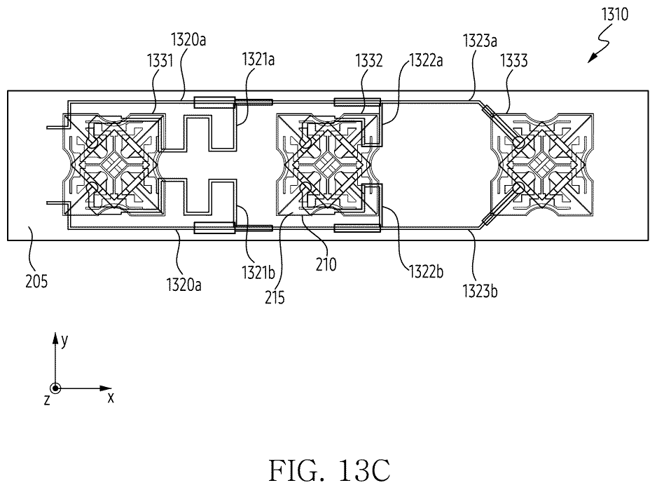

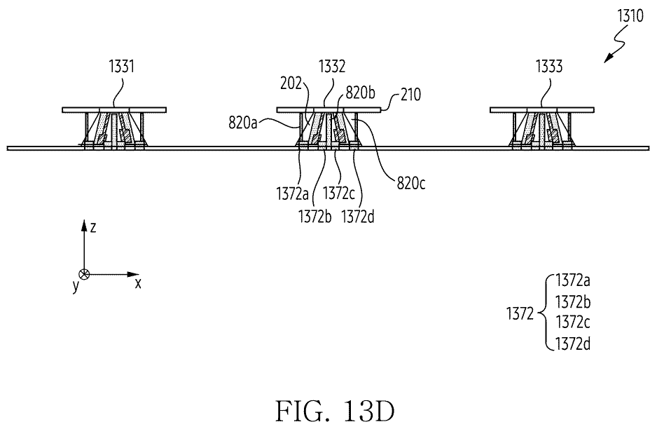

FIGS. 13A to 13D indicates examples of an antenna module including a radiation structure for a dipole antenna according to various embodiments of the disclosure. In FIGS. 13A to 13D, an example of an antenna module with an array antenna including the antenna element (e.g., the antenna element 200 of FIGS. 2A to 2C, the antenna element 200 of FIGS. 3A to 3C, or the antenna element 200 of FIGS. 8A to 8C) described through FIGS. 2A to 2C, 3A to 3C, 4, 5A, 5B, 6A, 6B, 7, 8A to 8C, 9 to 11, and 12A to 12C is described. The base station 110, the terminal 120, and/or other communication equipment (e.g., MMU) of FIG. 1 may include the antenna module.

Referring to FIG. 13A, the antenna module may include an array antenna 1300. The array antenna 1300 may include a plurality of sub-arrays. For example, the array antenna 1300 may include the plurality of sub-arrays arranged in a horizontal direction (e.g., an x axis direction) and a vertical direction (e.g., a y axis direction). As an example, the array antennas 1300 may be arranged eight by eight in the horizontal direction and four by four in the vertical direction, thereby including a total of 32 sub-arrays. The array antenna 1300 may include a sub-array 1310. The sub-array 1310 may include a plurality of antenna elements. For example, the sub-array 1310 may include three antenna elements. The three antenna elements may be arranged in a direction (e.g., the y axis direction).

Referring to FIG. 13B, a perspective view of the sub-array 1310 is illustrated. Referring to FIG. 13C, a top plan view of the sub-array 1310 is illustrated. The sub-array 1310 may include a plurality of antenna elements. For example, the plurality of antenna elements may include a first antenna element 1331, a second antenna element 1332, and a third antenna element 1333. Exemplarily, the second antenna element 1332 is described as a reference. The second antenna element 1332 may include a support portion 202 and a substrate portion 201 (e.g., a non-conductive substrate 210 and a metal pattern 215). For description of each antenna element of the plurality of antenna elements, the radiation structure for the antenna element 200 described in FIGS. 2A to 2C and 3A to 3C may be referred to.

The sub-array 1310 may include at least one conductive pattern formed on an insulating plate 205. The at least one conductive pattern may include a first conductive pattern 1320a and a second conductive pattern 1320b. The first conductive pattern 1320a may be associated with a first polarization. Wireless communication circuitry (e.g., RFIC, or communication chip) may be configured to feed signals of the first polarization to the first conductive pattern 1320a. The second conductive pattern 1320b may be associated with a second polarization. The wireless communication circuitry may be configured to feed the signals of the first polarization to the first conductive pattern 1320a. For example, the first polarization may be a vertical (V)-polarization, and the second polarization may be a horizontal (H)-polarization. For example, the first polarization may be a (+) about 45 degrees polarization, and the second polarization may be a (−) about 45 degrees polarization.

The first conductive pattern 1320a may include three branches. Each branch may be provided as a feeding portion of an antenna element (e.g., the first antenna element 1331, the second antenna element 1332, and the third antenna element 1333). For example, the first conductive pattern 1320a may include a first branch 1321a for the first polarization and the first antenna element 1331, a second branch 1322a for the first polarization and the second antenna element 1332, and a third branch 1323a for the first polarization and the third antenna element 1333. The second conductive pattern 1320b may include three branches. Each branch may be provided as a feeding portion of an antenna element (e.g., the first antenna element 1331, the second antenna element 1332, and the third antenna element 1333). For example, the second conductive pattern 1320b may include a first branch 1321b for the second polarization and the first antenna element 1331, a second branch 1322b for the second polarization and the second antenna element 1332, and a third branch 1323b for the second polarization and the third antenna element 1333. For descriptions regarding the radiation structure for the antenna element 200 described in FIGS. 2A to 2C and 3A to 3C, the second antenna element 1332 is illustrated. The second branch 1322b of the second conductive pattern 1320b may be connected to a second feeding portion 232 for the second antenna element 1332.

Referring to FIG. 13D, a front view of the sub-array 1310 is illustrated. The sub-array 1310 may include a plurality of antenna elements. For example, the plurality of antenna elements may include the first antenna element 1331, the second antenna element 1332, and the third antenna element 1333. For description regarding each antenna element of the plurality of antenna elements, the radiation structure for the antenna element 200 described in FIGS. 2A to 2C and 3A to 3C may be referred to.

According to an embodiment, the second antenna element 1332 may include the support portion 202 for supporting the non-conductive substrate 210 of the substrate portion 201. The support portion 202 may be configured to support the non-conductive substrate 210 so as to be spaced apart from the insulating plate 205 in a direction (e.g., a +z axis direction). The second antenna element 1332, which is a structure for controlling a beam width and/or a beam gain as well as the support portion 202, may include pillar structures (e.g., a first pillar structure 820a, a second pillar structure 820b, and a third pillar structure 820c).

According to an embodiment, the second antenna element 1332 may include connection structures 1372 (e.g., conductive vias) for connection between the support portion 202 and the insulating plate 205. The connection structures 1372 may include a first connection structure 1372a, a second connection structure 1372b, a third connection structure 1372c, and a fourth connection structure 1372d. For example, the first connection structure 1372a and the second connection structure 1372b may be configured to connect the insulating plate 205 to a first side area 220a of the support portion 202. For example, the third connection structure 1372c and the fourth connection structure 1372d may be configured to connect the insulating plate 205 to a second side area 220b of the support portion 202. Each connection structure may be configured to electrically connect a ground area of the support portion 202 to a ground of the insulating plate 205. For example, the first connection structure 1372a and the second connection structure 1372b may be configured to electrically connect a first ground area 227a to the ground of the insulating plate 205. For example, the third connection structure 1372c and the fourth connection structure 1372d may be configured to electrically connect a second ground area 227b to the ground of the insulating plate 205.

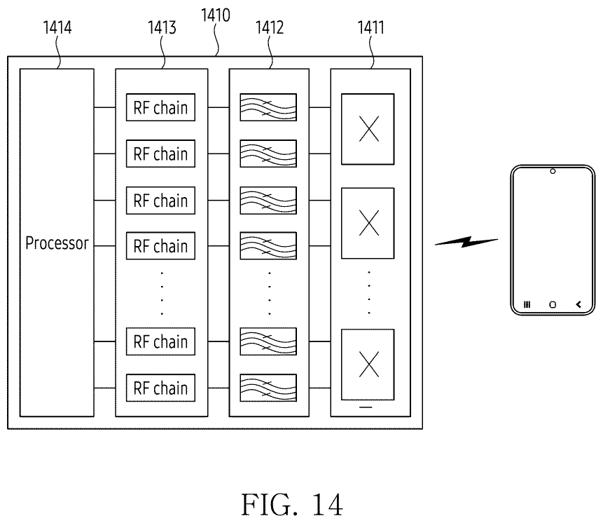

FIG. 14 illustrates an example of a functional component of an electronic device including a radiation structure for a dipole antenna according to an embodiment of the disclosure. An electronic device 1410 may be the base station 110 of FIG. 1 or the MMU of the base station 110. Meanwhile, unlike the illustration, it is not excluded that the electronic device 1410 of the disclosure may be implemented in the terminal 120 of FIG. 1.

Referring to FIG. 14, a functional configuration of an electronic device 1410 is illustrated. The electronic device 1410 may include an antenna unit 1411, a filter unit 1412, a radio frequency (RF) processing unit 1413, and a processor 1414.

The antenna unit 1411 may include a plurality of antennas (e.g., the antenna element 200 of FIGS. 2A to 2C, and 3A to 3C, and the antenna element 200 of FIGS. 8A to 8C). An antenna performs functions for transmitting and receiving signals through a wireless channel. The antenna may include a conductor formed on a substrate (e.g., a PCB) or a radiator formed of a conductive pattern. The antenna may radiate an up-converted signal on the wireless channel or obtain a signal radiated from another device. Each antenna may be referred to as an antenna element or an antenna device. In partial embodiments, the antenna unit 1411 may include an antenna array in which a plurality of antenna elements form an array. The antenna unit 1411 may be electrically connected to the filter unit 1412 through RF signal lines. The antenna unit 1411 may be mounted on the PCB including a plurality of antenna elements. The PCB may include a plurality of RF signal lines connecting each antenna element to a filter of the filter unit 1412. These RF signal lines may be referred to as a feeding network.

The filter unit 1412 may perform filtering to transfer a signal of a desired frequency. The filter unit 1412 may perform a function for selectively identifying a frequency by forming a resonance. The filter unit 1412 may include at least one of a band pass filter, a low pass filter, a high pass filter, and a band reject filter. That is, the filter unit 1412 may include RF circuitry for obtaining signals of a frequency band for transmission or a frequency band for reception. The filter unit 1412 according to various embodiments may electrically connect the antenna unit 1411 to the RF processing unit 1413.

The RF processing unit 1413 may include a plurality of RF paths. An RF path may be a unit of a path through which a signal received through an antenna or a signal radiated through the antenna passes. At least one RF path may be referred to as an RF chain. The RF chain may include a plurality of RF elements. The RF elements may include an amplifier, a mixer, an oscillator, a DAC, an ADC, and the like. For example, the RF processing unit 1413 may include an up converter that up-converts a digital transmission signal of a base band into a transmission frequency, and a digital-to-analog converter (DAC) that converts the up-converted digital transmission signal into an analog RF transmission signal. The upconverter and the DAC form a portion of a transmission path. The transmission path may further include a power amplifier (PA) or a coupler (or a combiner). For example, the RF processing unit 1413 may include an analog-to-digital converter (ADC) that converts an analog RF reception signal into a digital reception signal and a down converter that converts the digital reception signal into a digital reception signal of a base band. The ADC and the downlink converter form a portion of a reception path. The reception path may further include a low-noise amplifier (LNA) or a coupler (or a divider). RF components of the RF processing unit 1413 may be implemented on the PCB. The base station 1410 may include a structure stacked in an order of the antenna unit 1411—the filter unit 1412—the RF processing unit 1413. The antennas and the RF components of the RF processing unit 1413 may be implemented on the PCB, and the filters may be repeatedly fastened between PCB and PCB to form a plurality of layers. For example, the RF processing unit 1413 may include a communication chip (e.g., RFIC).

The processor 1414 may control overall operations of the electronic device 1410. The processor 1414 may be referred to as a control part, a controller, or a control unit. The processor 1414 may include various modules for performing communication. The processor 1414 may include at least one processor such as a modem. The processor 1414 may include modules for digital signal processing. For example, the processor 1414 may include a modem. When transmitting data, the processor 1414 generates complex symbols by encoding and modulating a transmission bit stream. In addition, for example, when receiving data, the processor 1414 restores the received bit stream by demodulating and decoding a baseband signal. The processor 1414 may perform functions of a protocol stack required by a communication standard.

In FIG. 14, functional components of the electronic device 1410 have been described as communication equipment including a dipole antenna according to embodiments of the disclosure. However, the example illustrated in FIG. 14 is merely a configuration for the radiation structure of the antenna module described with reference to FIGS. 1, 2A to 2C, 3A to 3C, 4, 5A, 5B, 6A, 6B, 7, 8A to 8C, 9 to 11, 12A to 12C, and 13A to 13D and for the use of the radiation structures, and the embodiments of the disclosure are not limited to the components of the equipment illustrated in FIG. 14. Accordingly, an antenna module including a radiation structure for a dipole antenna, communication equipment, and the radiation structure itself may also be understood as an embodiment of the disclosure.

In embodiments, an antenna module is provided. The antenna module may comprise an insulating plate 205 including at least one conductive pattern, and a plurality of radiation structures disposed on a surface of the insulating plate 205. Each radiation structure of the plurality of radiation structures may comprise a substrate portion 201 and a support portion 202 disposed between the substrate portion 201 and the insulating plate 205. The substrate portion 201 may comprise a non-conductive substrate 210 and a metal pattern 215 formed on the non-conductive substrate and configured to radiate signals. The support portion 101 may comprise a plurality of side areas 220 and a feeding area 230. The at least one conductive pattern may be electrically connected to a first feeding portion 231 for a first polarization and a second feeding portion 232 for a second polarization. The first feeding portion 231 may be disposed along at least one first side area among the plurality of side areas 220 of the support portion 202 and the feeding area 230. The second feeding portion 232 may be disposed along at least one second side area among the plurality of side areas 220 of the support portion 202 and the feeding area 230.

According to an embodiment, the plurality of side areas 220 of the support portion 202 may include a plurality of inner surfaces and a plurality of outer surfaces. The plurality of inner surfaces may include the at least one first side area and the at least one second side area. A conductive portion for a ground may be formed on each outer surface of the plurality of outer surfaces.

According to an embodiment, at least a portion of the first feeding portion 231 may be disposed on a first surface of the feeding area 230 of the support portion 202. At least a portion of the second feeding portion 232 may be disposed on a second surface opposite to the first surface of the feeding area 230 of the support portion 202.

According to an embodiment, the plurality of side areas may be disposed to connect between the substrate portion and the insulating plate in an inclined posture according to a predetermined inclination.

According to an embodiment, the at least one conductive pattern may include a first conductive pattern for the first polarization and a second conductive pattern for the second polarization. The first conductive pattern may be electrically connected to the first feeding portion 231. The second conductive pattern may be electrically connected to the second feeding portion 232. The first polarization and the second polarization may be substantially perpendicular.

According to an embodiment, the first feeding portion 231 may comprise a first feeding segment formed on the surface of the insulating plate 205, a second feeding segment connecting between the surface of the insulating plate 205 and another surface opposite to the surface, a third feeding segment formed on the other surface of the insulating plate 205, a fourth feeding segment formed along one side area of the at least one first side area of the support portion 202, a fifth feeding segment formed along the feeding area 230 of the support portion 202, and a sixth feeding segment formed along another side area of the at least one first side area of the support portion 202.

According to an embodiment, it may further comprise a first conductive via for electrically connecting the fourth feeding segment and the fifth feeding segment, and a second conductive via for electrically connecting the fifth feeding segment and the sixth feeding segment. Each of the first conductive via and the second conductive via may be disposed over the feeding area.

According to an embodiment, the second feeding portion 232 may comprise a first feeding segment formed on the surface of the insulating plate 205, a second feeding segment connecting between the surface of the insulating plate 205 and the other surface opposite to the surface, a third feeding segment formed on the other surface of the insulating plate 205, a fourth feeding segment formed along one side area of the at least one second side area of the support portion 202, a fifth feeding segment formed along the feeding area 230 of the support portion 202, and a sixth feeding segment formed along another side area of the at least one second side area of the support portion 202.

According to an embodiment, it may further comprise at least one via for coupling each side area of the plurality of side areas 220 and the insulating plate 205. A shape of the at least one via may comprise rectangular cross sections.

According to an embodiment, a shape of the support portion 202 may be a frustum of quadrangular pyramid. A width of the feeding area 230 of the support portion 202 may be smaller than a width of an area where the support portion 202 is coupled to the insulating plate 205.

According to an embodiment, the non-conductive substrate 210 of the substrate portion 201 and the support portion 202 may be dielectrics of same materials and are integrally formed.

According to an embodiment, each side portion of the side areas of the support portion 202 may be disposed to maintain a constant distance from the insulating plate 205 to the substrate portion 201. The feeding area 230 of the support portion 202 may be disposed substantially parallel to the substrate portion 201.

According to an embodiment, the metal pattern 215 may comprise a first pattern part, a second pattern part, a third pattern part, and a fourth pattern part. Each of the first pattern part, the second pattern part, the third pattern part, and the fourth pattern part may be used as a radiator of a folded dipole antenna through the first feeding portion 231 and the second feeding portion 232 of the feeding area 230.

According to an embodiment, it may further comprise a plurality of pillar structures disposed between the insulating plate 205 and the substrate portion 201. A conductive portion may be formed on at least a portion of each pillar structure of the plurality of pillar structures.

According to an embodiment, the plurality of pillar structures may be disposed to surround the support portion 202. A shape of the conductive portion has a longest length in a direction from the insulating plate 205 to the substrate portion 201.

According to an embodiment, a side area of the plurality of side areas 220 of the support portion 202 and the insulating plate 205 may be coupled through at least one conductive via. The at least one conductive via may be configured to electrically connect a ground area formed on a surface of the side area and a ground of the insulating plate 205.

In embodiments, a communication apparatus is provided. The communication apparatus may comprise a processor 1414, at least one wireless communication circuitry 1413, and an antenna module comprising a plurality of sub-arrays 1300. For each sub-array 1310, the antenna module may comprise an insulating plate 205 including at least one conductive pattern, and a plurality of radiation structures disposed on a surface of the insulating plate 205. Each radiation structure of the plurality of radiation structures may comprise a substrate portion 201 and a support portion 202 disposed between the substrate portion 201 and the insulating plate 205. The substrate portion 201 may comprise a non-conductive substrate 210 and a metal pattern 215 formed on the non-conductive substrate 210 and configured to radiate signals. The support portion 101 may comprise a plurality of side areas 220 and a feeding area 230. The at least one conductive pattern may be electrically connected to a first feeding portion 231 for a first polarization and a second feeding portion 232 for a second polarization. The first feeding portion 231 may be disposed along at least one first side area among the plurality of side areas 220 of the support portion 202 and the feeding area 230. The second feeding portion 232 may be disposed along at least one second side area among the plurality of side areas 220 of the support portion 202 and the feeding area 230.

According to an embodiment, each wireless communication circuitry 1413 of the at least one wireless communication circuitry 1413 may be configured to supply signals to two or more radiating structures among the plurality of radiating structures.

According to an embodiment, the plurality of side areas 220 of the support portion 202 may include a plurality of inner surfaces and a plurality of outer surfaces. The plurality of inner surfaces may include the at least one first side area and the at least one second side area. A conductive portion for ground may be formed on each outer surface of the plurality of outer surfaces.

According to an embodiment, at least a portion of the first feeding portion 231 may be disposed on a first surface of the feeding area 230 of the support portion 202. At least a portion of the second feeding portion 232 may be disposed on a second surface opposite to the first surface of the feeding area 230 of the support portion 202.

Methods according to embodiments described in claims or specifications of the disclosure may be implemented as a form of hardware, software, or a combination of hardware and software.

In a case of implementing as software, a computer-readable storage medium for storing one or more programs (software module) may be provided. The one or more programs stored in the computer-readable storage medium are configured for execution by one or more processors in an electronic device. The one or more programs include instructions that cause the electronic device to execute the methods according to embodiments described in claims or specifications of the disclosure. The one or more programs may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. In the case of being distributed online, at least part of the computer program product may be temporarily generated or at least temporarily stored in the machine-readable storage medium, such as memory of the manufacturer's server, the application store's server, or a relay server.

Such a program (software module, software) may be stored in a random access memory, a non-volatile memory including a flash memory, a read only memory (ROM), an electrically erasable programmable read only memory (EEPROM), a magnetic disc storage device, an optical storage device (e.g., a compact disc-ROM (CD-ROM), digital versatile discs (DVDs), or other formats), or a magnetic cassette. Alternatively, it may be stored in memory configured with a combination of some or all of them. In addition, a plurality of configuration memories may be included.

Additionally, a program may be stored in an attachable storage device that may be accessed through a communication network such as the Internet, Intranet, local area network (LAN), wide area network (WAN), or storage area network (SAN), or a combination thereof. Such a storage device may be connected to a device performing an embodiment of the disclosure through an external port. In addition, a separate storage device on the communication network may also be connected to a device performing an embodiment of the disclosure.

In the above-described specific embodiments of the disclosure, components included in the disclosure are expressed in the singular or plural according to the presented specific embodiment. However, the singular or plural expression is selected appropriately according to a situation presented for convenience of explanation, and the disclosure is not limited to the singular or plural component, and even components expressed in the plural may be configured in the singular, or a component expressed in the singular may be configured in the plural.

According to various embodiments, one or more components or operations of the above-described components may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to various embodiments, operations performed by the module, the program, or another component may be executed sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An antenna module, comprising:
an insulating plate including at least one conductive pattern; and
a plurality of radiation structures disposed on a surface of the insulating plate,
wherein each radiation structure of the plurality of radiation structures comprises a substrate portion and a support portion disposed between the substrate portion and the insulating plate,
wherein the substrate portion comprises a non-conductive substrate and a metal pattern formed on the non-conductive substrate and configured to radiate signals,
wherein the support portion comprises a plurality of side areas and a feeding area,
wherein the at least one conductive pattern is electrically connected to a first feeding portion for a first polarization and a second feeding portion for a second polarization,
wherein the first feeding portion is disposed along at least one first side area among the plurality of side areas of the support portion and the feeding area, and
wherein the second feeding portion is disposed along at least one second side area among the plurality of side areas of the support portion and the feeding area.

2. The antenna module of claim 1,
wherein the plurality of side areas of the support portion includes a plurality of inner surfaces and a plurality of outer surfaces,
wherein the plurality of inner surfaces includes the at least one first side area and the at least one second side area, and
wherein a conductive portion for a ground is formed on each outer surface of the plurality of outer surfaces.

3. The antenna module of claim 1,
wherein at least a portion of the first feeding portion is disposed on a first surface of the feeding area of the support portion, and
wherein at least a portion of the second feeding portion is disposed on a second surface opposite to the first surface of the feeding area of the support portion.

4. The antenna module of claim 1, wherein the plurality of side areas are disposed to connect between the substrate portion and the insulating plate in an inclined posture according to a predetermined inclination.

5. The antenna module of claim 1,
wherein the at least one conductive pattern includes a first conductive pattern for the first polarization and a second conductive pattern for the second polarization,
wherein the first conductive pattern is electrically connected to the first feeding portion,
wherein the second conductive pattern is electrically connected to the second feeding portion, and
wherein the first polarization and the second polarization are substantially perpendicular.

6. The antenna module of claim 1, wherein the first feeding portion comprises:
a first feeding segment formed on the surface of the insulating plate;
a second feeding segment connecting between the surface of the insulating plate and another surface opposite to the surface;
a third feeding segment formed on the other surface of the insulating plate;
a fourth feeding segment formed along one side area of the at least one first side area of the support portion;
a fifth feeding segment formed along the feeding area of the support portion; and
a sixth feeding segment formed along another side area of the at least one first side area of the support portion.

7. The antenna module of claim 6, further comprising:
a first conductive via for electrically connecting the fourth feeding segment and the fifth feeding segment; and
a second conductive via for electrically connecting the fifth feeding segment and the sixth feeding segment,
wherein each of the first conductive via and the second conductive via is disposed over the feeding area.

8. The antenna module of claim 7, wherein the second feeding portion comprises:
a first feeding segment formed on the surface of the insulating plate;
a second feeding segment connecting between the surface of the insulating plate and the other surface opposite to the surface;
a third feeding segment formed on the other surface of the insulating plate;
a fourth feeding segment formed along one side area of the at least one second side area of the support portion;
a fifth feeding segment formed along the feeding area of the support portion; and
a sixth feeding segment formed along another side area of the at least one second side area of the support portion.

9. The antenna module of claim 1, further comprising:
at least one via for coupling each side area of the plurality of side areas and the insulating plate,
wherein a shape of the at least one via comprises rectangular cross sections.

10. The antenna module of claim 1,
wherein a shape of the support portion is a frustum of quadrangular pyramid, and
wherein a width of the feeding area of the support portion is smaller than a width of an area where the support portion is coupled to the insulating plate.

11. The antenna module of claim 1, wherein the non-conductive substrate of the substrate portion and the support portion are dielectrics of same materials and are integrally formed.

12. The antenna module of claim 1,
wherein each side portion of the side areas of the support portion is disposed to maintain a constant distance from the insulating plate to the substrate portion, and
wherein the feeding area of the support portion is disposed substantially parallel to the substrate portion.

13. The antenna module of claim 1,
wherein the metal pattern comprises a first pattern part, a second pattern part, a third pattern part, and a fourth pattern part, and
wherein each of the first pattern part, the second pattern part, the third pattern part, and the fourth pattern part are used as a radiator of a folded dipole antenna through the first feeding portion and the second feeding portion of the feeding area.

14. The antenna module of claim 1, further comprising:
a plurality of pillar structures disposed between the insulating plate and the substrate portion,
wherein a conductive portion is formed on at least a portion of each pillar structure of the plurality of pillar structures,
wherein the plurality of pillar structures are disposed to surround the support portion, and
wherein a shape of the conductive portion has a longest length in a direction from the insulating plate to the substrate portion.

15. A communication apparatus comprising:
a processor;
at least one wireless communication circuitry; and
an antenna module comprising a plurality of sub-arrays,
wherein, for each sub-array, the antenna module comprises:
an insulating plate including at least one conductive pattern, and
a plurality of radiation structures disposed on a surface of the insulating plate,
wherein each radiation structure of the plurality of radiation structures comprises a substrate portion and a support portion disposed between the substrate portion and the insulating plate,
wherein the substrate portion comprises a non-conductive substrate and a metal pattern formed on the non-conductive substrate and configured to radiate signals,
wherein the support portion comprises a plurality of side areas and a feeding area,
wherein the at least one conductive pattern is electrically connected to a first feeding portion for a first polarization and a second feeding portion for a second polarization,
wherein the first feeding portion is disposed along at least one first side area among the plurality of side areas of the support portion and the feeding area, and
wherein the second feeding portion is disposed along at least one second side area among the plurality of side areas of the support portion and the feeding area.

16. The communication apparatus of claim 15,
wherein the plurality of side areas of the support portion includes a plurality of inner surfaces and a plurality of outer surfaces,
wherein the plurality of inner surfaces includes the at least one first side area and the at least one second side area, and
wherein a conductive portion for a ground is formed on each outer surface of the plurality of outer surfaces.

17. The communication apparatus of claim 15,
wherein at least a portion of the first feeding portion is disposed on a first surface of the feeding area of the support portion, and
wherein at least a portion of the second feeding portion is disposed on a second surface opposite to the first surface of the feeding area of the support portion.

18. The communication apparatus of claim 15, wherein the plurality of side areas are disposed to connect between the substrate portion and the insulating plate in an inclined posture according to a predetermined inclination.

19. The communication apparatus of claim 15,
wherein the at least one conductive pattern includes a first conductive pattern for the first polarization and a second conductive pattern for the second polarization,
wherein the first conductive pattern is electrically connected to the first feeding portion,
wherein the second conductive pattern is electrically connected to the second feeding portion, and
wherein the first polarization and the second polarization are substantially perpendicular.

20. The communication apparatus of claim 15, wherein the first feeding portion comprises:
a first feeding segment formed on the surface of the insulating plate;
a second feeding segment connecting between the surface of the insulating plate and another surface opposite to the surface;
a third feeding segment formed on the other surface of the insulating plate;
a fourth feeding segment formed along one side area of the at least one first side area of the support portion;
a fifth feeding segment formed along the feeding area of the support portion; and
a sixth feeding segment formed along another side area of the at least one first side area of the support portion.
